(19) United States
(12) Patent Application Publication
(10) Pub. No.: US 2026/0295869 A1
(43) Pub. Date: Oct. 1, 2026

(54) SYSTEMS, METHODS, AND APPARATUSES FOR MANIPULATING CONTAINERS

(71) Applicant: Boston Dynamics, Inc., Waltham, MA (US)

(72) Inventors: Kihyeon Bae, Belmont, MA (US); Seokwon Lee, Boston, MA (US); Seok Woo Lee, Boston, MA (US); Hyunkyoo Park, Cambridge, MA (US); Hojun Ji, Cambridge, MA (US)

(73) Assignee: Boston Dynamics, Inc., Waltham, MA (US)

(21) Appl. No.: 19/413,647

(22) Filed: Dec. 9, 2025

Related U.S. Application Data
(60) Provisional application No. 63/780,645, filed on Mar. 31, 2025.

(51) Int. Cl. B25J 15/06; B25J 9/16

(52) U.S. Cl. CPC B25J 15/0616; B25J 9/1679; B25J 9/1697

(57) ABSTRACT

Method and apparatus for manipulating a container and other types of objects, such as parcels and/or slip sheets, using a robotic end effector of a mobile robot are provided. Image data representing one or more parcels and one or more containers is used to identify a first container located a first position in an environment of a mobile robot.

The mobile robot is controlled to pull the first container to a second position in the environment using a hook assembly coupled to a vacuum-based gripper of the mobile robot. When the first container is located at the second position, the vacuum-based gripper is activated to grasp a second container using at least one vacuum assembly of the vacuum-based gripper.

### TECHNICAL FIELD

This disclosure relates generally to robotics, and more specifically to systems, methods and apparatuses for manipulating containers in an environment of a mobile robot.

### BACKGROUND

A robot is generally defined as a reprogrammable and multifunctional manipulator designed to move material, parts, tools, and/or specialized devices (e.g., via variable programmed motions) for performing tasks. Robots may include manipulators that are physically anchored (e.g., industrial robotic arms), mobile devices that move throughout an environment (e.g., using legs, wheels, or traction-based mechanisms), or some combination of one or more manipulators and one or more mobile devices. Robots are currently used in a variety of industries, including, for example, manufacturing, warehouse logistics, transportation, hazardous environments, exploration, and healthcare.

### SUMMARY

For logistic workflows in warehouse environments, manipulation of a mixture of types of objects, including containers configured to house one or more objects, and parcels (e.g., boxes) using a robot is desirable. Some containers may have constraints for effective manipulation of the container using a robotic end effector. For example, it may be desired and/or necessary for a robotic end effector with a vacuum-based gripper to grasp the container in a particular way to facilitate a secure grasp of the container using the vacuum-based gripper. As one example, it may be advantageous or otherwise desired for the robotic end effector to grasp a particular face of the container with the vacuum-based gripper. However, based on a current pose of the container and/or other objects in proximity to the container to be grasped, the particular face of the container may not be accessible to the vacuum-based gripper in some situations (e.g., when the container is located in a stack of containers in a truck). Due, at least in part, to such constraints, some logistic workflows using a robot may not attempt to perform tasks that involve robotic manipulation of both containers and parcels. Some embodiments of the present disclosure relate to a robotic end effector configured to manipulate containers and other types of objects, such as parcels and/or slip sheets, which may be included in the environment of the robot. For example, a robotic end effector designed in accordance with one or more of the techniques described herein may include a vacuum-based gripper and a hook assembly. The hook assembly may enable the robotic end effector to engage with and pull the container into a position where the container may be grasped using the vacuum-based gripper.

In some embodiments, the invention features a robotic end effector for a mobile robot. The robotic end effector includes a vacuum-based gripper including a set of vacuum assemblies, and a hook assembly configured to engage with a portion of a container, the hook assembly including a first portion mechanically coupled to the vacuum-based gripper and a second portion extending at a first angle relative to the first portion, the first portion extending at a second angle relative to a suction direction of the set of vacuum assemblies.

In one aspect, the robotic end effector further comprises an adapter plate mechanically coupled to the first portion of the hook assembly and at least one vacuum assembly in the set of vacuum assemblies. In another aspect, the adapter plate includes at least one opening through which at least a portion of the at least one vacuum assembly extends. In another aspect, the first portion of the hook assembly is mechanically coupled to at least one vacuum assembly in the set of vacuum assemblies, and the robotic end effector further comprises at least one washer positioned between the first portion of the hook assembly and the at least one vacuum assembly. In another aspect, the robotic end effector further comprises at least one magnet and/or spring mechanically coupled to the first portion of the hook assembly and the vacuum-based gripper, wherein the at least one magnet and/or spring is configured to decouple from the hook assembly and/or the vacuum-based gripper when a force applied to at least a portion of the hook assembly exceeds a threshold amount of force.

In another aspect, the portion of the container is a handle of the container. In another aspect, the handle of the container extends outward from a side of the container, and wherein the second portion of the hook assembly is configured to engage with a bottom portion and/or a top portion of the handle. In another aspect, the second portion of the hook assembly has a width configured to fit within the handle of the container.

In some embodiments, the invention features a method. The method includes identifying, using first image data including a representation of one or more parcels and one or more containers, a first container located at a first position in an environment of a mobile robot, controlling the mobile robot to pull the first container from the first position to a second position in the environment using a hook assembly coupled to a vacuum-based gripper of the mobile robot, and activating the vacuum-based gripper to grasp a second container using at least one vacuum assembly of the vacuum-based gripper when the first container is located at the second position.

In one aspect, the first container and the second container are a same container. In another aspect, the first container and/or the second container is a tote. In another aspect, identifying, using the first image data, the first container located at the first position comprises identifying a third container represented in the first image data and identifying the first container, based, at least in part, on identifying the third container. In another aspect, identifying the first container is based, at least in part, on the first container and the third container being aligned in a column. In another aspect, the second container and the third container are a same container.

In another aspect, the method further comprises identifying, using the first image data, at least one corner of the first container and determining, based, at least in part, on the at least one corner and distance-based measurement data for the first container, a pose of the first container, wherein controlling the mobile robot to use the hook assembly to pull the first container from the first position to the second position in the environment is based, as least in part, on the pose of the first container.

In another aspect, identifying, using the first image data, the first container located at the first position in the environment of the mobile robot comprises determining, using a machine learning (ML) model, that a first object represented in the first image data corresponds to a container and identifying the first container, based, at least in part, on determining the first object corresponds to a container. In another aspect, the method further comprises verifying that the first object corresponds to a container based on the first object having a first characteristic of a container and identifying the first container, based, at least in part, on verifying that the first object corresponds to a container. In another aspect, the verifying that the first object corresponds to a container based on the first object having the first characteristic of a container comprises determining dimensions of the first object match predetermined dimensions of a container.

In another aspect, the method further comprises determining a first pose of the first container, determining a second pose of the third container, and adjusting the first pose and the second pose to include a same orientation and position in at least two planes based on the first container and the third container being aligned in a column, wherein controlling the mobile robot to use the hook assembly to pull the first container from the first position to the second position is based on the first pose. In another aspect, controlling the mobile robot to use the hook assembly to pull the first container from the first position to the second position comprises determining whether a first portion of a first face of the second container is represented in the first image data when the first container is in the first position and controlling the mobile robot to use the hook assembly to pull the first container from the first position to the second position when it is determined that the first portion of first face of the second container is not represented in the first image data. In another aspect, determining whether the first portion of the first face of the second container is represented in the first image data when the first container is in the first position comprises determining with an entire surface of the first face of the second container is represented in the first image data when the first container is in the first position.

In another aspect, controlling the mobile robot to use the hook assembly to pull the first container from the first position to the second position comprises determining whether at least one object represented in the first image data is graspable using the at least one vacuum assembly of the vacuum-based gripper and controlling the mobile robot to use the hook assembly to pull the first container from the first position to the second position when it is determined that the first portion of the first face of the second container is not represented in the first image data and the at least one object is not graspable using the at least one vacuum assembly of the vacuum-based gripper.

In another aspect, the at least one object includes a first parcel and a first slip sheet, and controlling the mobile robot to use the hook assembly to pull the first container from the first position to the second position comprises determining whether the first parcel is graspable using the at least one vacuum assembly of the vacuum-based gripper, wherein the first parcel is in a third position, determining whether the first slip sheet is graspable using the at least one vacuum assembly of the vacuum-based gripper when it is determined that the first parcel is not graspable using the at least one vacuum assembly of the vacuum-based gripper when the first parcel is in the third position, wherein the first slip sheet is in a fourth position, determining whether the first face of the second container is graspable using the at least one vacuum assembly of the vacuum-based gripper when it is determined that the first slip sheet is not graspable using the at least one vacuum assembly of the vacuum-based gripper when the first slip sheet is in the fourth position, and controlling the mobile robot to use the hook assembly to pull the first container from the first position to the second position when it is determined that the first face of the second container is at least partially hidden from view in the first image data, the first parcel is not graspable using the at least one vacuum assembly of the vacuum-based gripper when the first parcel is in the third position, and the first slip sheet is not graspable using the at least one vacuum assembly of the vacuum-based gripper when the first slip sheet is in the fourth position.

In another aspect, controlling the mobile robot to use the hook assembly to pull the first container from the first position to the second position comprises controlling the mobile robot to engage the hook assembly with a handle of the first container and controlling the mobile robot to pull the first container from the first position to the second position via the hook assembly when engaged with the handle of the first container. In another aspect, controlling the mobile robot to use the hook assembly engaged with the handle of the first container to pull the first container from the first position to the second position comprises controlling the mobile robot to move an arm of the mobile robot, to which the vacuum-based gripper is coupled, to pull the first container from the first position to the second position. In another aspect, controlling the mobile robot to use the hook assembly engaged with the handle of the first container to pull the first container from the first position to the second position comprises controlling the mobile robot to drive a base of the mobile robot to pull the first container from the first position to the second position. In another aspect, controlling the mobile robot to use the hook assembly to pull the first container from the first position to the second position comprises determining whether at least one face of the first container is at least partially hidden from view in the first image data by at least one object and controlling the mobile robot to use the hook assembly to pull the first container from the first position to the second position when it is determined that the at least one face of the first container is at least partially hidden from view in the first image data by the at least one object.

In another aspect, the method further comprises activating the vacuum-based gripper to grasp the at least one object when it is determined that the at least one face of the first container is partially hidden in the first image data by the at least one object, placing the at least one object at a target location, and controlling the mobile robot to use the hook assembly to pull the first container from the first position to the second position after placing the at least one object at the target location. In another aspect, the at least one object includes the one or more parcels or a slip sheet. In another aspect, the at least one face includes a top face of the first container and a bottom face of the first container and controlling the mobile robot to use the hook assembly to pull the first container from the first position to the second position comprises controlling the mobile robot to use the hook assembly to pull the first container from the first position to the second position when it is determined that the top face of the first container is not covered by a first object of the at least one object and the bottom face of the first container is not covered by a second object of the at least one object.

In another aspect, the first container is included in a column of containers and controlling the mobile robot to use the hook assembly to pull the first container from the first position to the second position comprises controlling the mobile robot to use the hook assembly to pull the column of containers from the first position to the second position by pulling the first container to the second position. In another aspect, controlling the mobile robot to use the hook assembly to pull the column of containers from the first position to the second position by pulling the first container to the second position comprises controlling the mobile robot to engage the hook assembly with a portion of the first container when it is determined that the first container is a bottom container in the column of containers. In another aspect, controlling the mobile robot to use the hook assembly to pull the first container from the first position to the second position comprises controlling the mobile robot to use the hook assembly to pull the first container at least a distance equal to a length of the first container. In another aspect, controlling the mobile robot to use the hook assembly to pull the first container from the first position to the second position comprises controlling the mobile robot to use the hook assembly to pull the first container from the first position to a third position, determining, using second image data, whether a first portion of first face of the first container is represented in the second image data, and controlling the mobile robot to use the hook assembly to pull the first container from the third position to the second position when it is determined that the first portion of the first face of the first container is not represented in the second image data.

In another aspect, the method further comprises activating the vacuum-based gripper to grasp the first container using the at least one vacuum assembly of the vacuum-based gripper when the first container is located at the second position comprises determining whether a first portion of a first face of the first container is represented in second image data representing the first container located at the second position and activating the vacuum-based gripper to grasp the first container using the at least one vacuum assembly of the vacuum-based gripper when it is determined that the first portion of the first face of the first container is represented in the second image data. In another aspect, the method further comprises activating the vacuum-based gripper to grasp the first container using the at least one vacuum assembly of the vacuum-based gripper when the first container is located at the second position comprises controlling the mobile robot to activate suction to the at least one vacuum assembly of the vacuum-based gripper and controlling the mobile robot to grasp a side face of the first container using the at least one vacuum assembly of the vacuum-based gripper, the side face being orthogonal to a front face and a top face of the first container. In another aspect, the method further comprises activating the vacuum-based gripper to grasp the first container using the at least one vacuum assembly of the vacuum-based gripper when the first container is located at the second position comprises controlling the mobile robot to orient the vacuum-based gripper in an orientation such that the hook assembly extends past a front face of the first container and controlling the mobile robot to grasp the first container using the at least one vacuum assembly of the vacuum-based gripper when the vacuum-based gripper is in the orientation.

In another aspect, the method further comprises receiving, from at least one first sensor, the first image data, wherein the at least one first sensor includes a sensor external to the mobile robot. In another aspect, the method further comprises receiving, from at least one first sensor, the first image data, wherein the at least one first sensor includes a sensor coupled to the mobile robot. In another aspect, the first container is in a first orientation when grasped using the at least one vacuum assembly of the vacuum-based gripper and the method further comprises controlling the mobile robot to place the first container at a target location, the first container being placed in the first orientation at the target location.

In another aspect, the method further comprises generating a trajectory for placing the first container in the target location, the trajectory including at least one first intermediate pose of the mobile robot, determining whether the first container is in the first orientation in the at least one first intermediate pose, determining whether a collision between the first container and at least one first surface is represented in the at least one first intermediate pose, generating at least one second intermediate pose when it is determined that the first container is not in the first orientation in the at least one first intermediate pose or there is a determined collision between the first container and the at least one first surface represented in the at least one first intermediate pose.

In some embodiments, the invention features a mobile robot. The mobile robot may include at least one first sensor configured to sense first image data, a robotic arm, a vacuum-based gripper coupled to the robotic arm, the vacuum-based gripper comprising at least one vacuum assembly and a hook assembly, and a controller configured to receive the first image data from the at least one first sensor, the first image data including a representation of one or more parcels and one or more containers in an environment of the mobile robot, identify, using the first image data, a first container located at a first position in the environment of the mobile robot, control the mobile robot to pull the first container from the first position to a second position in the environment using the hook assembly, and activate the vacuum-based gripper to grasp a second container using the at least one vacuum assembly when the first container is located at the second position.

In one aspect, the first container and the second container are a same container. In another aspect, the first container and/or the second container is a tote. In another aspect, identifying, using the first image data, the first container located at the first position comprises identifying a third container represented in the first image data and identifying the first container, based, at least in part, on identifying the third container. In another aspect, identifying the first container is based, at least in part, on the first container and the third container being aligned in a column. In another aspect, the second container and the third container are a same container.

In another aspect, the controller is further configured to identify, using the first image data, at least one corner of the first container and determine, based, at least in part, on the at least one corner and distance-based measurement data for the first container, a pose of the first container, wherein controlling the mobile robot to use the hook assembly to pull the first container from the first position to the second position in the environment is based, as least in part, on the pose of the first container. In another aspect, identifying, using the first image data, the first container located at the first position in the environment of the mobile robot comprises determining, using a machine learning (ML) model, that a first object represented in the first image data corresponds to a container and identifying the first container, based, at least in part, on determining the first object corresponds to a container. In another aspect, the controller is further configured to verify that the first object corresponds to a container based on the first object having a first characteristic of a container and identify the first container, based, at least in part, on verifying that the first object corresponds to a container. In another aspect, verifying that the first object corresponds to a container based on the first object having the first characteristic of a container comprises determining dimensions of the first object match predetermined dimensions of a container. In another aspect, the controller is further configured to determine a first pose of the first container, determine a second pose of the third container, and adjust the first pose and the second pose to include a same orientation; and position in at least two planes based on the first container and the third container being aligned in a column, wherein controlling the mobile robot to use the hook assembly to pull the first container from the first position to the second position is based on the first pose.

In another aspect, controlling the mobile robot to use the hook assembly to pull the first container from the first position to the second position comprises determining whether a first portion of a first face of the second container is represented in the first image data when the first container is in the first position and controlling the mobile robot to use the hook assembly to pull the first container from the first position to the second position when it is determined that the first portion of first face of the second container is not represented in the first image data. In another aspect, determining whether the first portion of the first face of the second container is represented in the first image data when the first container is in the first position comprises determining with an entire surface of the first face of the second container is represented in the first image data when the first container is in the first position. In another aspect, controlling the mobile robot to use the hook assembly to pull the first container from the first position to the second position comprises determining whether at least one object represented in the first image data is graspable using the at least one vacuum assembly of the vacuum-based gripper and controlling the mobile robot to use the hook assembly to pull the first container from the first position to the second position when it is determined that the first portion of the first face of the second container is not represented in the first image data and the at least one object is not graspable using the at least one vacuum assembly of the vacuum-based gripper.

In another aspect, the at least one object includes a first parcel and a first slip sheet and controlling the mobile robot to use the hook assembly to pull the first container from the first position to the second position comprises determining whether the first parcel is graspable using the at least one vacuum assembly of the vacuum-based gripper, wherein the first parcel is in a third position, determining whether the first slip sheet is graspable using the at least one vacuum assembly of the vacuum-based gripper when it is determined that the first parcel is not graspable using the at least one vacuum assembly of the vacuum-based gripper when the first parcel is in the third position, wherein the first slip sheet is in a fourth position, determining whether the first face of the second container is graspable using the at least one vacuum assembly of the vacuum-based gripper when it is determined that the first slip sheet is not graspable using the at least one vacuum assembly of the vacuum-based gripper when the first slip sheet is in the fourth position, and controlling the mobile robot to use the hook assembly to pull the first container from the first position to the second position when it is determined that the first face of the second container is at least partially hidden from view in the first image data, the first parcel is not graspable using the at least one vacuum assembly of the vacuum-based gripper when the first parcel is in the third position, and the first slip sheet is not graspable using the at least one vacuum assembly of the vacuum-based gripper when the first slip sheet is in the fourth position.

In another aspect, controlling the mobile robot to use the hook assembly to pull the first container from the first position to the second position comprises controlling the mobile robot to engage the hook assembly with a handle of the first container and controlling the mobile robot to pull the first container from the first position to the second position via the hook assembly when engaged with the handle of the first container. In another aspect, controlling the mobile robot to use the hook assembly engaged with the handle of the first container to pull the first container from the first position to the second position comprises controlling the mobile robot to move an arm of the mobile robot, to which the vacuum-based gripper is coupled, to pull the first container from the first position to the second position. In another aspect, controlling the mobile robot to use the hook assembly engaged with the handle of the first container to pull the first container from the first position to the second position comprises controlling the mobile robot to drive a base of the mobile robot to pull the first container from the first position to the second position. In another aspect, controlling the mobile robot to use the hook assembly to pull the first container from the first position to the second position comprises determining whether at least one face of the first container is at least partially hidden from view in the first image data by at least one object and controlling the mobile robot to use the hook assembly to pull the first container from the first position to the second position when it is determined that the at least one face of the first container is at least partially hidden from view in the first image data by the at least one object.

In another aspect, the controller is further configured to activate the vacuum-based gripper to grasp the at least one object when it is determined that the at least one face of the first container is partially hidden in the first image data by the at least one object, place the at least one object at a target location, and control the mobile robot to use the hook assembly to pull the first container from the first position to the second position after placing the at least one object at the target location. In another aspect, the at least one object includes the one or more parcels or a slip sheet. In another aspect, the at least one face includes a top face of the first container and a bottom face of the first container and controlling the mobile robot to use the hook assembly to pull the first container from the first position to the second position comprises controlling the mobile robot to use the hook assembly to pull the first container from the first position to the second position when it is determined that the top face of the first container is not covered by a first object of the at least one object and the bottom face of the first container is not covered by a second object of the at least one object.

In another aspect, the first container is included in a column of containers and controlling the mobile robot to use the hook assembly to pull the first container from the first position to the second position comprises controlling the mobile robot to use the hook assembly to pull the column of containers from the first position to the second position by pulling the first container to the second position. In another aspect, controlling the mobile robot to use the hook assembly to pull the column of containers from the first position to the second position by pulling the first container to the second position comprises controlling the mobile robot to engage the hook assembly with a portion of the first container when it is determined that the first container is a bottom container in the column of containers.

In another aspect, controlling the mobile robot to use the hook assembly to pull the first container from the first position to the second position comprises controlling the mobile robot to use the hook assembly to pull the first container at least a distance equal to a length of the first container. In another aspect, controlling the mobile robot to use the hook assembly to pull the first container from the first position to the second position comprises controlling the mobile robot to use the hook assembly to pull the first container from the first position to a third position, determining, using second image data, whether a first portion of first face of the first container is represented in the second image data, and controlling the mobile robot to use the hook assembly to pull the first container from the third position to the second position when it is determined that the first portion of the first face of the first container is not represented in the second image data.

In another aspect, activating the vacuum-based gripper to grasp the first container using the at least one vacuum assembly of the vacuum-based gripper when the first container is located at the second position comprises determining whether a first portion of a first face of the first container is represented in second image data representing the first container located at the second position and activating the vacuum-based gripper to grasp the first container using the at least one vacuum assembly of the vacuum-based gripper when it is determined that the first portion of the first face of the first container is represented in the second image data. In another aspect, activating the vacuum-based gripper to grasp the first container using the at least one vacuum assembly of the vacuum-based gripper when the first container is located at the second position comprises controlling the mobile robot to activate suction to the at least one vacuum assembly of the vacuum-based gripper and controlling the mobile robot to grasp a side face of the first container using the at least one vacuum assembly of the vacuum-based gripper, the side face being orthogonal to a front face and a top face of the first container.

In another aspect, activating the vacuum-based gripper to grasp the first container using the at least one vacuum assembly of the vacuum-based gripper when the first container is located at the second position comprises controlling the mobile robot to orient the vacuum-based gripper in an orientation such that the hook assembly extends past a front face of the first container and controlling the mobile robot to grasp the first container using the at least one vacuum assembly of the vacuum-based gripper when the vacuum-based gripper is in the orientation.

In another aspect, the controller is further configured to receive, from at least one first sensor, the first image data, wherein the at least one first sensor includes a sensor external to the mobile robot. In another aspect, the controller is further configured to receive, from at least one first sensor, the first image data, wherein the at least one first sensor includes a sensor coupled to the mobile robot. In another aspect, the first container is in a first orientation when grasped using the at least one vacuum assembly of the vacuum-based gripper and the controller is further configured to control the mobile robot to place the first container at a target location, the first container being placed in the first orientation at the target location.

In another aspect, the controller is further configured to generate a trajectory for placing the first container in the target location, the trajectory including at least one first intermediate pose of the mobile robot, determine whether the first container is in the first orientation in the at least one first intermediate pose, determine whether a collision between the first container and at least one first surface is represented in the at least one first intermediate pose, and generate at least one second intermediate pose when it is determined that the first container is not in the first orientation in the at least one first intermediate pose or there is a determined collision between the first container and the at least one first surface represented in the at least one first intermediate pose.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is a perspective view of a robot, according to an illustrative embodiment of the invention.

FIG. 4A is a perspective view of a robotic end effector, according to an illustrative embodiment of the invention.

FIG. 4B is a bottom view of the robotic end effector shown in FIG. 4A, according to an illustrative embodiment of the invention.

FIG. 4C is an exploded view of a portion of the robotic end effector shown in FIG. 4A, according to an illustrative embodiment of the invention.

FIG. 5 is a flowchart of a process for manipulating objects in a stack of objects, according to an illustrative embodiment of the invention.

FIG. 6 is a flowchart of a process for manipulating a container, according to an illustrative embodiment of the invention.

FIG. 7 is a flowchart of a process for perceiving objects in an environment of the mobile robot, according to an illustrative embodiment of the invention.

FIG. 8 is a flowchart of a process for selecting an object to be manipulated, according to an illustrative embodiment of the invention.

FIGS. 9A-9E depict steps in a process for pulling a container using a hook assembly of a robotic end effector, according to an illustrative embodiment of the invention.

FIG. 10 depicts a process for grasping a container using a vacuum-based gripper of a mobile robot, according to an illustrative embodiment of the invention.

FIG. 11A depicts an unsuccessful grasp attempt of a container using a vacuum-based gripper of a mobile robot, according to an illustrative embodiment of the invention.

FIG. 11B depicts a successful grasp attempt of a container using vacuum-based gripper of a mobile robot after pulling a column of containers in which the container is arranged toward the robot, according to an illustrative embodiment of the invention.

FIGS. 12A-12B depict positions of a hook assembly of a vacuum-based gripper when attempting to grasp a container, according to an illustrative embodiment of the invention.

FIG. 13 is a flowchart of a process for optimizing a virtual trajectory for moving a grasped container, according to an illustrative embodiment of the invention.

FIG. 14 illustrates a configuration of a robotic system, according to an illustrative embodiment of the invention.

### DETAILED DESCRIPTION

The following detailed description describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Robots can be configured to perform a number of tasks in an environment in which they are placed. Exemplary tasks may include interacting with (e.g., manipulating) objects and/or elements of the environment, such as parcels, slip sheets, and/or containers.

Some robots configured to manipulate parcels (e.g., boxes) may have reduced capabilities to manipulate containers when a combination of containers and parcels are present in the environment of the robot, such as in a stack of objects. For example, whereas some parcels may be grasped using a vacuum-based gripper of a robotic end effector from any of a set of faces of the parcel, it may be desirable and/or necessary to grasp a container with a vacuum-based gripper in a particular way (e.g., on a particular face (or a subset of faces) of the container). In situations in which the particular face of the container is not accessible to be grasped with the vacuum-based gripper, (e.g., when containers are stacked in a truck), a human may need to intervene and assist the robot with manipulating such containers. To expand the capability and efficiency of robots to work on tasks including manipulation of a combination of containers and other objects, some embodiments of the present disclosure relate to a robotic end effector that includes a vacuum-based gripper and a hook assembly. The hook assembly may be configured to enable the robotic end effector to manipulate (e.g., pull) containers into a position where they can be grasped by the vacuum-based gripper.

To date, both specialist and generalist warehouse robots have been associated with significant limitations. For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

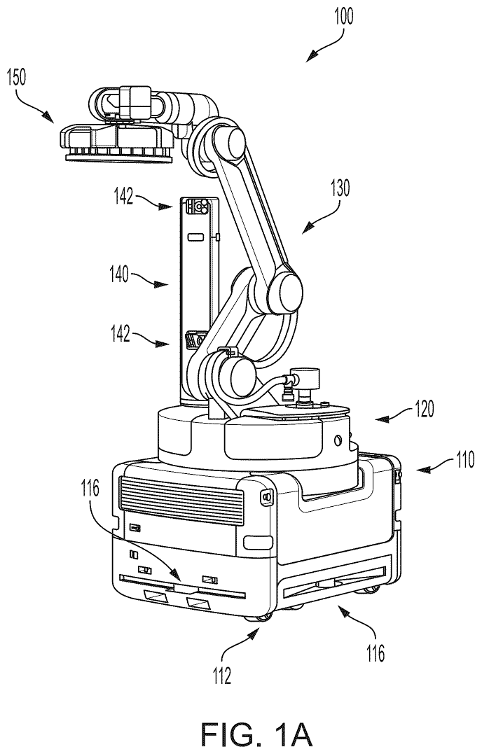

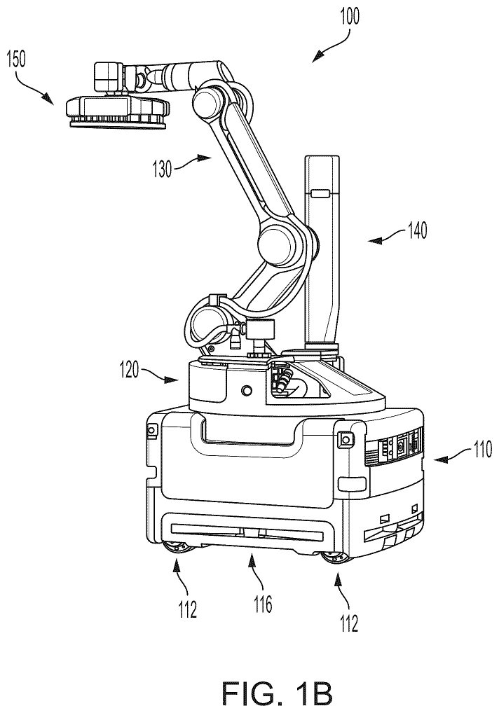

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

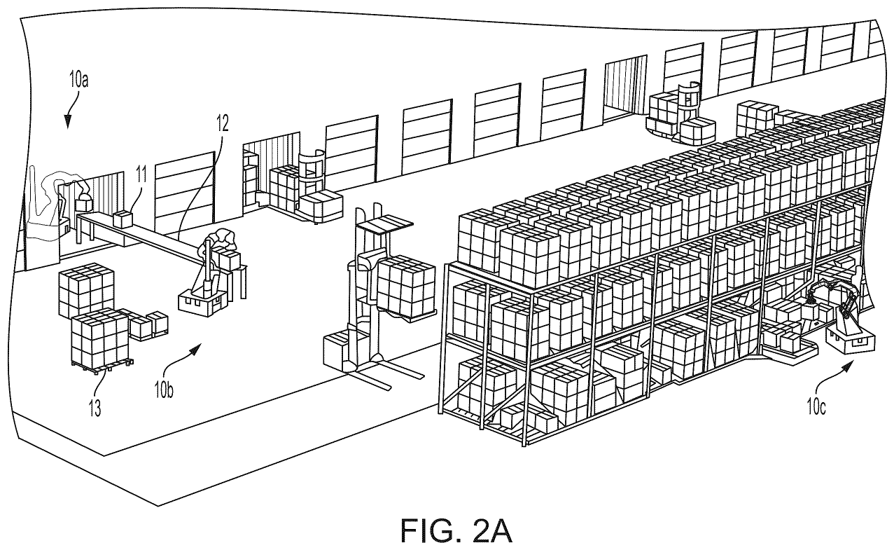

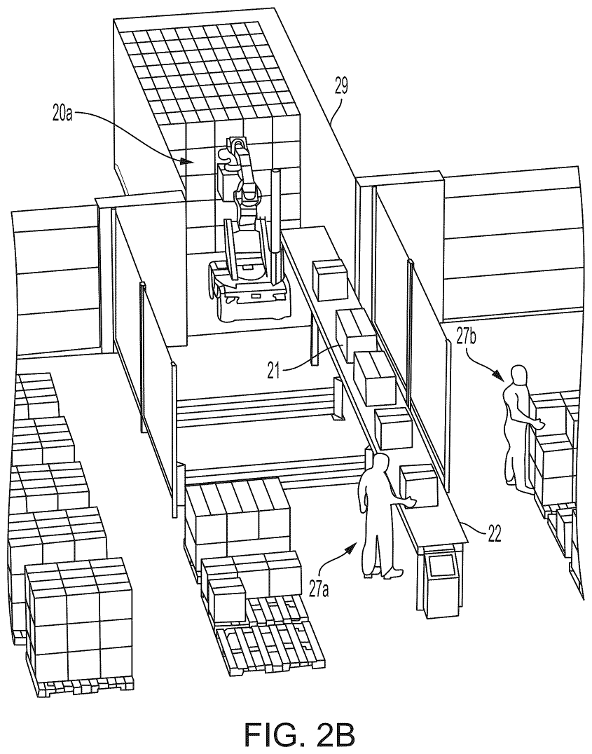

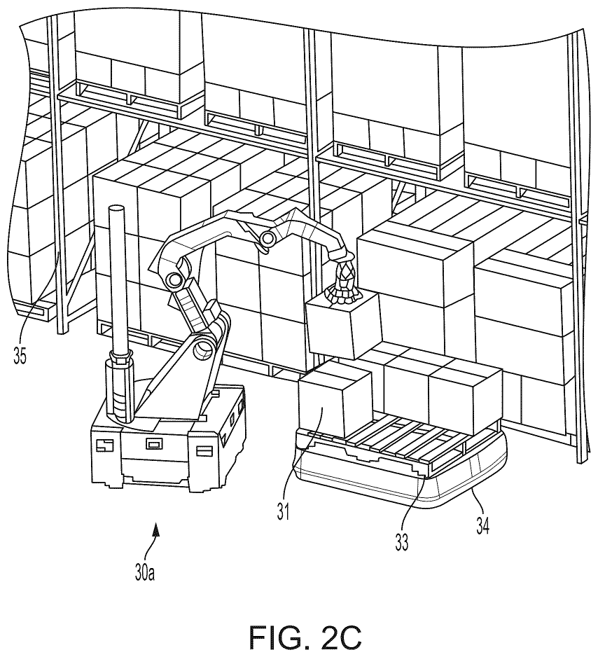

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety field around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container, placing objects on a conveyor belt; removing objects from a conveyor belt; organizing objects into a stack; organizing objects on a pallet; placing objects on a shelf; organizing objects on a shelf, removing objects from a shelf; picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

### Example Robotic Arm

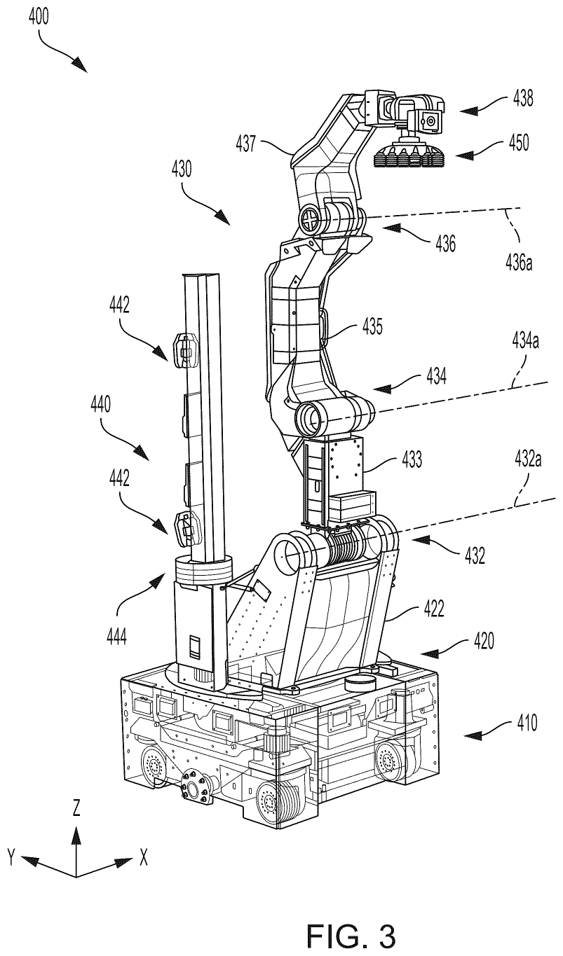

FIG. 3 is a perspective view of a robot 400, according to an illustrative embodiment of the invention. The robot 400 includes a mobile base 410 and a turntable 420 rotatably coupled to the mobile base. A robotic arm 430 is operatively coupled to the turntable 420, as is a perception mast 440. The perception mast 440 includes an actuator 444 configured to enable rotation of the perception mast 440 relative to the turntable 420 and/or the mobile base 410, so that a direction of the perception modules 442 of the perception mast may be independently controlled.

The robotic arm 430 of FIG. 3 is a 6-DOF robotic arm. When considered in conjunction with the turntable 420 (which is configured to yaw relative to the mobile base about a vertical axis parallel to the Z axis), the arm/turntable system may be considered a 7-DOF system. The 6-DOF robotic arm 430 includes three pitch joints 432, 434, and 436, and a 3-DOF wrist 438 which, in some embodiments, may be a spherical 3-DOF wrist.

Starting at the turntable 420, the robotic arm 430 includes a turntable offset 422, which is fixed relative to the turntable 420. A distal portion of the turntable offset 422 is rotatably coupled to a proximal portion of a first link 433 at a first joint 432. A distal portion of the first link 433 is rotatably coupled to a proximal portion of a second link 435 at a second joint 434. A distal portion of the second link 435 is rotatably coupled to a proximal portion of a third link 437 at a third joint 436. The first, second, and third joints 432, 434, and 436 are associated with first, second, and third axes 432a, 434a, and 436a, respectively.

The first, second, and third joints 432, 434, and 436 are additionally associated with first, second, and third actuators (not labeled) which are configured to rotate a link about an axis. Generally, the nth actuator is configured to rotate the nth link about the nth axis associated with the nth joint. Specifically, the first actuator is configured to rotate the first link 433 about the first axis 432a associated with the first joint 432, the second actuator is configured to rotate the second link 435 about the second axis 434a associated with the second joint 434, and the third actuator is configured to rotate the third link 437 about the third axis 436a associated with the third joint 436. In the embodiment shown in FIG. 3, the first, second, and third axes 432a, 434a, and 436a are parallel (and, in this case, are all parallel to the X axis). In the embodiment shown in FIG. 3, the first, second, and third joints 432, 434, and 436 are all pitch joints.

In some embodiments, a robotic arm of a highly integrated mobile manipulator robot may include a different number of degrees of freedom than the robotic arms discussed above. Additionally, a robotic arm need not be limited to a robotic arm with three pitch joints and a 3-DOF wrist. A robotic arm of a highly integrated mobile manipulator robot may include any suitable number of joints of any suitable type, whether revolute or prismatic. Revolute joints need not be oriented as pitch joints, but rather may be pitch, roll, yaw, or any other suitable type of joint.

Returning to FIG. 3, the robotic arm 430 includes a wrist 438. As noted above, the wrist 438 is a 3-DOF wrist, and in some embodiments may be a spherical 3-DOF wrist. The wrist 438 is coupled to a distal portion of the third link 437. The wrist 438 includes three actuators configured to rotate an end effector 450 coupled to a distal portion of the wrist 438 about three mutually perpendicular axes. Specifically, the wrist may include a first wrist actuator configured to rotate the end effector relative to a distal link of the arm (e.g., the third link 437) about a first wrist axis, a second wrist actuator configured to rotate the end effector relative to the distal link about a second wrist axis, and a third wrist actuator configured to rotate the end effector relative to the distal link about a third wrist axis. The first, second, and third wrist axes may be mutually perpendicular. In embodiments in which the wrist is a spherical wrist, the first, second, and third wrist axes may intersect.

In some embodiments, an end effector may be associated with one or more sensors. For example, a force/torque sensor may measure forces and/or torques (e.g., wrenches) applied to the end effector. Alternatively or additionally, a sensor may measure wrenches applied to a wrist of the robotic arm by the end effector (and, for example, an object grasped by the end effector) as the object is manipulated. Signals from these (or other) sensors may be used during mass estimation and/or path planning operations. In some embodiments, sensors associated with an end effector may include an integrated force/torque sensor, such as a 6-axis force/torque sensor. In some embodiments, separate sensors (e.g., separate force and torque sensors) may be employed. Some embodiments may include only force sensors (e.g., uniaxial force sensors, or multi-axis force sensors), and some embodiments may include only torque sensors. In some embodiments, an end effector may be associated with a custom sensing arrangement. For example, one or more sensors (e.g., one or more uniaxial sensors) may be arranged to enable sensing of forces and/or torques along multiple axes. An end effector (or another portion of the robotic arm) may additionally include any appropriate number or configuration of cameras, distance sensors, pressure sensors, light sensors, or any other suitable sensors, whether related to sensing characteristics of the payload or otherwise, as the disclosure is not limited in this regard.

As described above, logistic operations performed by a robot may involve manipulation of various types of objects, such as containers, parcels, and/or slip sheets (e.g., thin sheets of material (plastic, paper, corrugated cardboard or metal) arranged between layers of stacked objects).

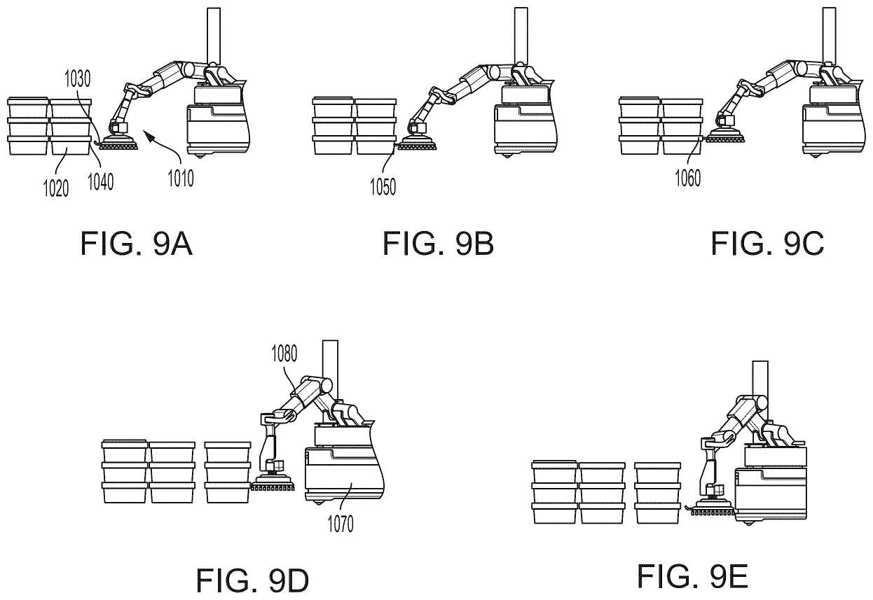

As used herein, a “container” may correspond to a type of object including particular features, including, but not limited to, one or more cavities configured to house one or more objects (e.g., parcels, loose (e.g., unsecured, unpackaged, etc.) items, etc.), a handle, and/or at least one recessed or protruding top surface upon which another container may be positioned (e.g., in a column). The recessed or protruding surface may be configured to interlock with one or more features of a bottom surface of a container positioned thereon to prevent the upper container from shifting relative to the lower container. In some embodiments, a container may be configured to be grasped (e.g., by a vacuum-based gripper) at a particular face (or subset of faces) of the container. If a container is in a position in which the particular face(s) is not graspable using the vacuum-based gripper (e.g., the face or subset of faces are at least partially blocked by other objects), the robot 100 may not attempt to grasp the container using the vacuum-based gripper. A human may then be summoned to move the container into a position in which it can be successfully grasped by the vacuum-based gripper or the human may be tasked with moving the container without the assistance of the robot 100. Although some examples described herein (e.g., in connection with FIGS. 9-12B) reference manipulation of a particular type of container (e.g., a tote), one skilled in the art will readily appreciate that other containers (e.g., bins, cases, etc.) with one or more similar features (e.g., one or more cavities, a handle, and/or a recessed or protruding top/bottom surface which may facilitate stacking containers) may also fall within the spirit and scope of the disclosure.

As used herein, a “parcel” may correspond to a type of object (e.g., a cardboard box) that may be successfully grasped using a vacuum-based gripper on any of a number of faces. In some instances, parcels may have varying configurations or structures, such as parcels having regular and/or rigid sides, parcels having irregular and/or non-rigid sides, etc.

As used herein, a “slip sheet” may correspond to a sheet of material (e.g., plastic, paper, corrugated cardboard or metal, etc.) configured to separate or divide one or more objects in a stack of objects. The slip sheet may be arranged between layers of objects in the stack of objects, such as between one or more parcels and one or more containers, between two or more parcels, between two or more containers, etc. Positioning a slip sheet between two or more objects may provide friction to the objects positioned above the slip sheet and/or provide coverage to the objects positioned below the slip sheet from the above objects. In some embodiments, the slip sheet may indicate a categorical separation between the objects, where the separated objects correspond to different objects (perishables vs. non-perishables, object A vs. object B, etc.), different types of objects (e.g., parcel, container, etc.), different customers, businesses, vendors, and/or merchants, etc.

The inventors have recognized and appreciated that some conventional robotic end effectors configured to grasp one type of objects (e.g., parcels) may have reduced capabilities to grasp other types of objects (e.g., containers) due, in part, to limitations on how the other types of objects may be successfully grasped by the robotic end effector. For example, it may not be possible, desirable, and/or advisable to grasp a container from a top surface using a vacuum-based gripper without risking damage to the container and/or the contents of the container. Rather, it may be desirable to grasp a side surface of the container using a vacuum-based gripper to ensure that the container is securely grasped and/or manipulated by the robotic end effector. Some embodiments are directed to a robotic end effector that includes a vacuum-based gripper and a hook assembly. The hook assembly may enable the robotic end effector to engage with and pull containers to a position in which they can be grasped by the vacuum-based end effector. Such a robotic end effector may increase a capability and efficiency of object manipulation (e.g., pick and place) operations of the robot to which it is attached.

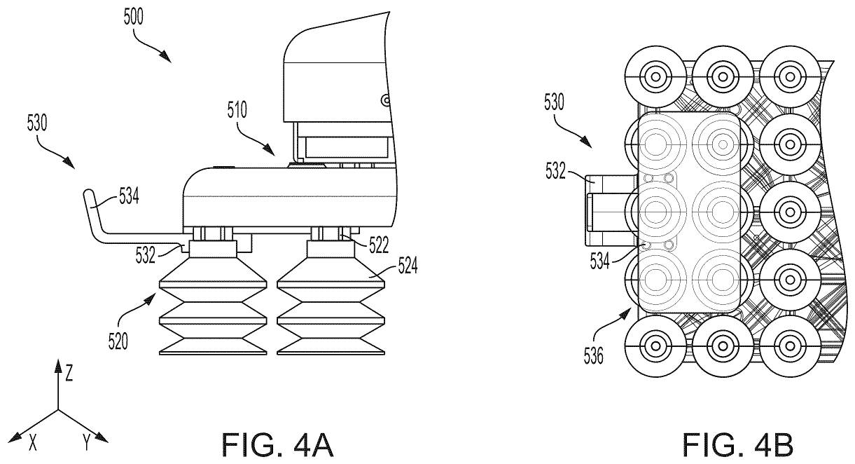

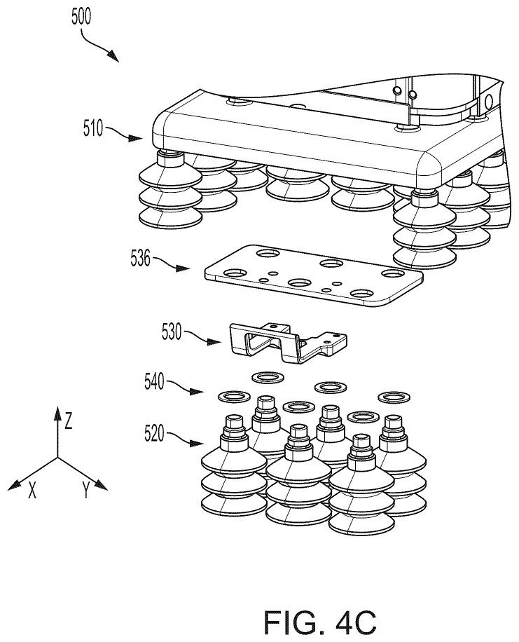

FIG. 4A illustrates a perspective view of an example of a robotic end effector 500. FIG. 4B illustrates a bottom view of the example robotic end effector 500. FIG. 4C illustrates an exploded view of a portion of the example robotic end effector 500. As shown in FIGS. 4A-4C, the robotic end effector 500 may include a vacuum-based gripper 510. The vacuum-based gripper 510 may be configured, when actuated, to grasp objects (e.g., parcels, slip sheets, containers, etc.) using suction. The vacuum-based gripper 510 may include one or more vacuum assemblies 520. A vacuum assembly 520 may include a suction cup 524 and a valve 522 through which vacuum may be provided from a vacuum source to the at least one suction cup 524. The valves 522 of the vacuum-based gripper 510 may be individually controllable such that activation of a valve 522 results in vacuum being provided to the respective suction cup 524 of the vacuum assembly. A set of vacuum assemblies 520 may be activated to enable the vacuum-based gripper 510 to grasp an object using suction.

The robotic end effector 500 may further include a hook assembly 530 configured to engage with a portion (e.g., a handle) of a container. The hook assembly 530 may include a first portion 532 configured to couple to vacuum-based gripper 510 and a second portion 534 arranged to extend at an angle relative to the first portion 532. In some embodiments, the first portion 532 of the hook assembly 530 may be mechanically coupled (e.g., using one or more forces, screws, bolts, etc.) to one or more of the vacuum assemblies 520 of the vacuum-based gripper 510. For example, as shown in FIG. 4A, hook assembly 530 may include a portion through which a portion of the one or more vacuum assemblies 520 may be inserted and secured.

In some embodiments, the first portion 532 of the hook assembly 530 may be mechanically coupled to the at least one suction cup 524 via an adapter plate 536 as shown in FIG. 4B. The adapter plate 536 may be positioned between a vacuum manifold of the vacuum-based gripper 510 and the first portion 532 of the hook assembly 530. In some embodiments, the adapter plate 536 may include at least one opening through which a portion of a vacuum assembly 520 (e.g., a portion of a valve 522 and/or a portion of at least one suction cup 524) may extend and be secured, effectively coupling the adapter plate 536 to the vacuum manifold of the vacuum-based gripper 510. The first portion 532 of the hook assembly 530 may be coupled to the adapter plate 536 via at least one fastening component, such as a screw, bolt and nut, solder, etc. In the example shown in FIGS. 4B and 4C, the adapter plate 536 is shown as having six openings through which six corresponding vacuum assemblies 520 are arranged. It should be appreciated, however, that adapter plate 536 may include any suitable number of openings (including a single opening) through which any suitable number of vacuum assemblies 520 (including a single vacuum assembly) may be arranged, and embodiments of the present disclosure are not limited in this respect. For example, in some embodiments, the adapter plate 536 is configured to be coupled to at least one vacuum assembly, at least two vacuum assemblies, at least four vacuum assemblies, at least six vacuum assemblies, etc.

In some embodiments, the hook assembly 530 may be configured to break away from the vacuum-based gripper 510 when a force applied to at least a portion of the hook assembly 530 exceeds a threshold value. For instance, the hook assembly 530 may be configured to break away from the vacuum-based gripper 510 when a portion of the hook assembly 530 collides with an object and/or surface with sufficient force. In this way, hook assembly 530 may provide a protective function by preventing or mitigating contact between the vacuum-based gripper 510 and the object and/or surface. The break away functionality of the hook assembly 530 may be implemented in any suitable way. For example, the first portion 532 of the hook assembly 530 may be mechanically coupled to the vacuum-based gripper 510 (e.g., to one or more of the vacuum assemblies 520 of the vacuum-based gripper 510) via at least one magnet, spring, and/or other fastening component. When a threshold force is applied to at least a portion of the hook assembly 530, the mechanical linkage between the hook assembly 530 and the vacuum-based gripper 510 may be broken, thereby allowing the hook assembly 530 to break away from the vacuum-based gripper 510.

In some embodiments, one or more washers 540 may be arranged between the first portion 534 of the hook assembly 530 and the portion of the at least one suction cup 524 against which it is mechanically coupled. In some embodiments, the at least one suction cup 524 may extend through both the washers 540 and the at least one opening of the adapter plate 536, such that the washers are seated against the adapter plate 536, instead of the hook assembly 530.

As shown in FIGS. 4A-C, the second portion 534 of the hook assembly 530 may be oriented at an angle relative to the first portion 532 to form a hook. The first portion 532 of the hook assembly 530 may extend at an angle relative to a suction direction of the vacuum assemblies 520. The suction direction of the vacuum assemblies 520 may correspond to the direction in which the suction cups 524 of the vacuum assemblies 520 are oriented, also referred to herein as the z-direction. The second portion 534 may be arranged at an angle relative to the first portion and be configured to engage with a portion (e.g., a handle) of a container. For example, the second portion 534 may engage with a bottom and/or top portion of a handle of the container. In some embodiments, the second portion 534 may have a width configured to fit within the handle of a container having known (e.g., standard) dimensions.

As described in more detail below, after engaging with a portion of a container, the hook assembly 530 may be used to pull the container across a surface to a position in which the container can be successfully grasped by the vacuum-based gripper 510.

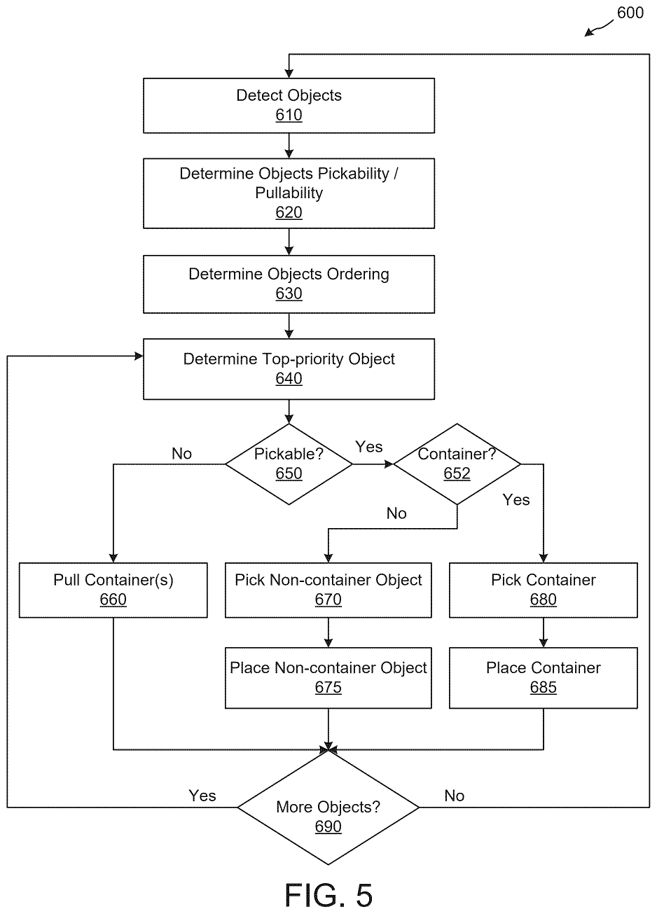

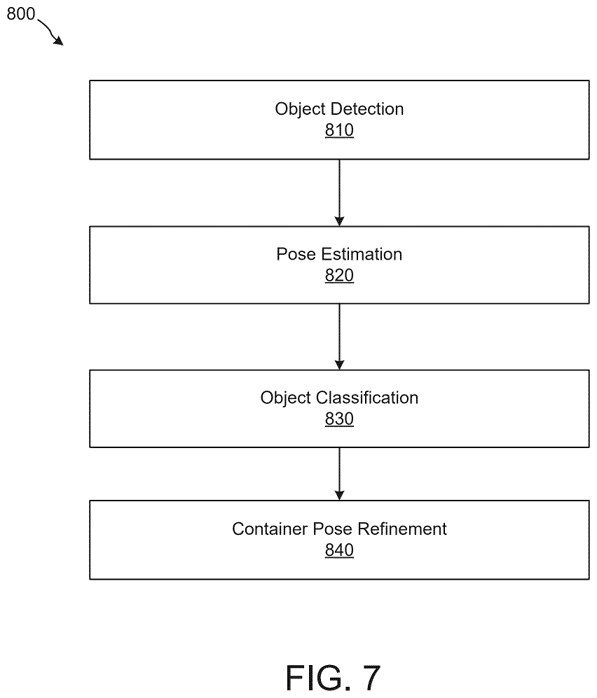

FIG. 5 is a flowchart of a process 600 for manipulating objects in a stack of objects including a container and at least one of a parcel or a slip sheet, in accordance with some embodiments. Process 600 may begin in act 610, where objects in an environment of the mobile robot may be detected. For instance, as described herein in connection with FIG. 7, image data received from at least one sensor (e.g., at least one RGBD camera module) may be used to detect objects (e.g., parcels, slip sheets, and/or container) in an environment of the mobile robot.

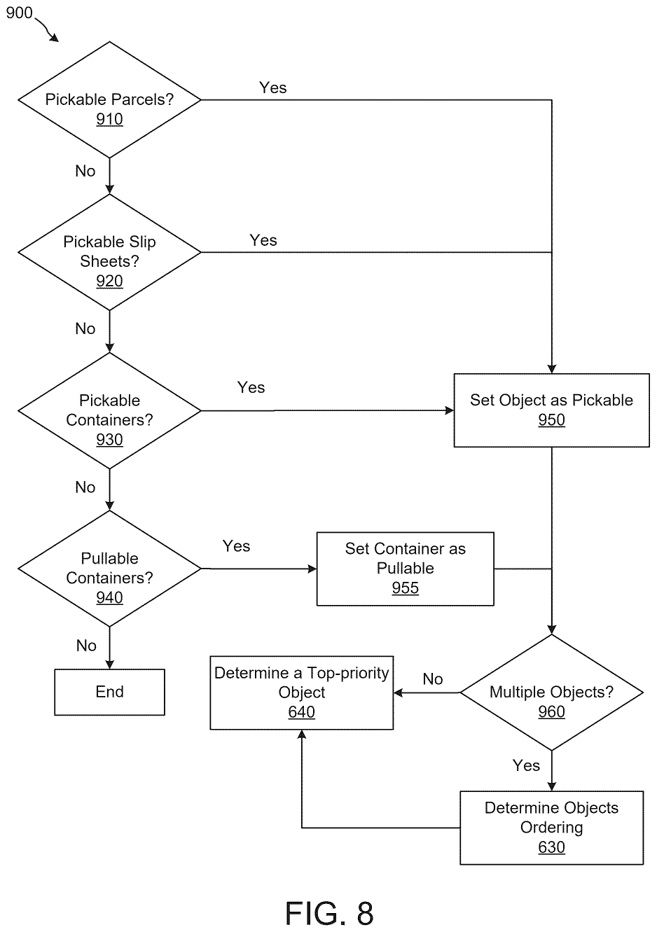

Process 600 may then proceed to act 620, where a pickability and pullability of the detected objects is determined. As described herein in connection with FIG. 8, a pickability of a detected object may represent whether the detected object has a pose in which the detected object may be grasped by the vacuum-based gripper of the mobile robot (e.g., picked). For example, it may be determined that a parcel is pickable when most or all of one or more of a top face, a front face or a side face of the parcel is represented in captured image data. As another example, it may be determined that a container is pickable when most or all of one or both of a top surface of the container and a side surface of the container is represented in the image data. A pullability of a detected object may represent whether a detected container, determined to not be pickable, is pullable using a hook assembly coupled to the vacuum-based gripper. For example, it may be determined that a container is pullable when a top surface of the container is represented in the image data received by the mobile robot and the container is not positioned on top of a parcel or slip sheet. As another example, it may be determined that a container is pullable when the container is a bottom-most container in a column of container and the top surface of a top-most container in the column of container is represented in the image data.

Process 600 may then proceed to act 630, where an order of manipulation of the detected objects is determined. As discussed herein in connection with FIG. 8, the order of manipulation of the detected objects may represent an order in which the detected objects are to be picked (e.g., grasped using the vacuum-based gripper) or pulled. In some embodiments, the order of manipulation may indicate the objects to be manipulated, a type of the objects (e.g., container, box, slip sheet, etc.), and an action to be performed to manipulate the objects (e.g., grasp or pull).

Process 600 may then proceed to act 640, where a top-priority object is determined. For instance, as discussed herein in connection with FIG. 8, the top-priority object may correspond to a detected object that is represented in the order of manipulation as the first object to be manipulated.

Process 600 may then proceed to act 650, where it is determined whether the top-priority object is pickable. If it is determined in act 650 that the object is pickable, process 600 may proceed to act 652, where is determine whether the pickable object is a container. It should be appreciated that it may alternatively be determined in act 652 whether the pickable object is a parcel, a slip sheet, and/or a different type of pickable object. If it is determined in act 652 that the pickable object is not a container, process 600 may proceed to act 670, where the non-container object (e.g., a parcel or slip sheet) is picked. For instance, as discussed herein, the vacuum-based gripper of the mobile robot may be activated to grasp a face of the detected non-container object using at least one vacuum assembly of the vacuum-based gripper. Process 600 may then proceed to act 675 where the mobile robot is controlled to place the non-container object at a target location (e.g., on a conveyor located near the mobile robot).

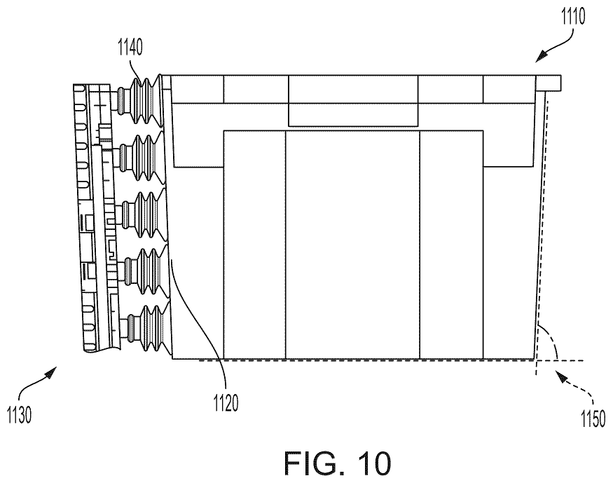

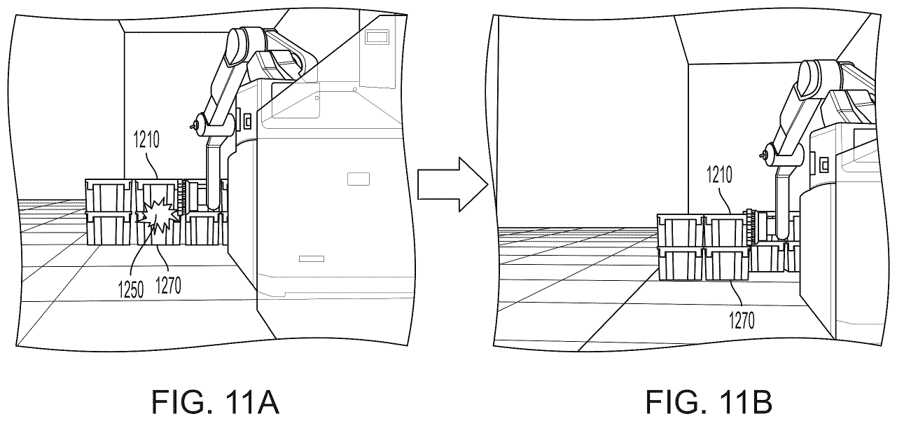

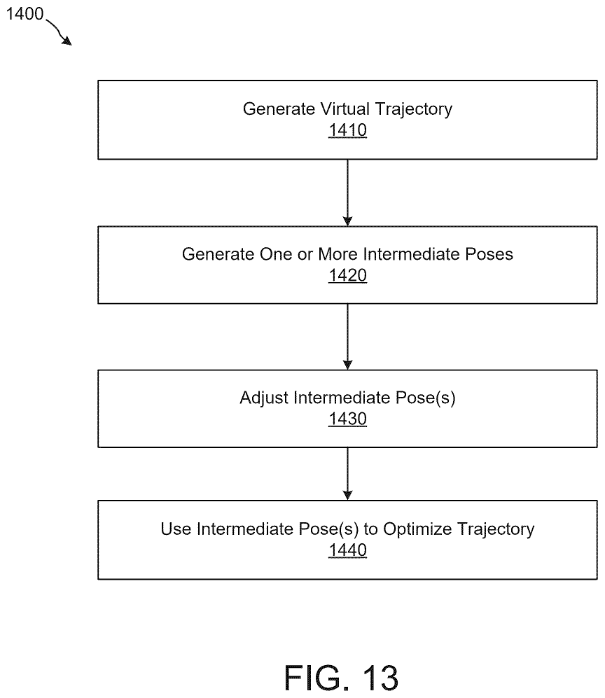

If it is determined in act 652 that the object is a container, process 600 may proceed to act 680 where the container is picked. For instance, as discussed herein in connection with FIGS. 10-11, the vacuum-based gripper of the mobile robot may be activated to grasp a particular face of the detected container using at least one vacuum assembly of the vacuum-based gripper, such as a side surface of the container. Process 600 may then proceed to act 685 where the mobile robot is controlled to place the container at a target location. For instance, as described herein in connection with FIG. 13, the mobile robot may generate and follow a virtual trajectory to move to and place the picked container in the target location. Generation of the virtual trajectory may include ensuring the container maintains a particular orientation (e.g., an upright orientation) when the mobile robot moves to and places the grasped container in the target location.

If it is determined in act 650 that the top priority object is not pickable, process 600 may proceed to act 660 where the object being identified as a container that is pullable (or is included in a column of container that is pullable), is pulled to a new position that enables the container to be picked. As discussed herein in connection with FIGS. 9A-9E, the detected container may be pulled using a hook assembly coupled to the vacuum-based gripper of the mobile robot. For example, the hook assembly may be configured to engage with a handle of the container. Once the hook assembly is engaged with the handle of the container, an arm of the mobile robot and/or the mobile base of the mobile robot may be moved to pull the container to a different position, such as a position where the container may be successfully grasped using the vacuum-based gripper.

After pulling the container(s) in act 660, placing the non-container object in act 675 or placing the container in act 685, process 600 may proceed to action 690, where it is determined whether there are any remaining objects to be manipulated. If there are objects remaining to be manipulated, process 600 may return to act 640, where a new top-priority object may be determined. If it is determined in act 690 that there are no objects remaining to be manipulated, process 600 may return to the act 610, where additional image data may be used to detect if there are any remaining objects in the environment that may be pickable or pullable. It should be appreciated that additional image data may be acquired and used to determine a next object to manipulate after performing any or all of acts 660, 675 or 685.

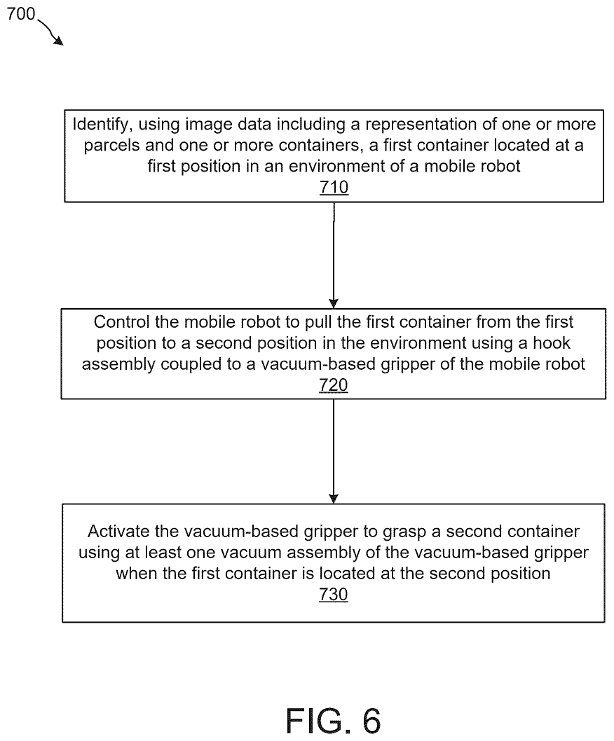

FIG. 6 is a flowchart of a process 700 for manipulating a container, in accordance with some embodiments. Process 700 may begin in act 710, where a first container located at a first position in an environment of a mobile robot is identified using image data including a representation of one or more parcels and one or more containers. For instance, as discussed herein in connection with FIG. 7, the mobile robot may receive image data from one or more sensors, which may be coupled to the mobile robot and/or external to the mobile robot, such as sensors located in an environment of the mobile robot. The mobile robot may identify the first container based on classifying a detected object as a container with a threshold level of confidence.

Process 700 may then proceed to act 720, where the mobile robot is controlled to pull the first container from the first position to a second position in the environment using a hook assembly coupled to a vacuum-based gripper of the mobile robot. For instance, the hook assembly may be engaged with a handle of the first container to pull the first container to the second position. The container may be pulled from the first position to the second position by pulling the container across a surface to the second position. In some embodiments, pulling the container from the first position to the second position may be achieve, at least in part, by controlling the mobile robot to move an arm of the mobile robot to which the vacuum-based gripper is coupled. In some embodiments, pulling the container from the first position to the second position may be achieved, at least in part, by controlling the mobile robot to move a base of the mobile robot in a direction that results in the container to be pulled. As described herein in connection with FIG. 8, the mobile robot may determine to pull the first container to the second position based, at least in part, on determining that the first container is not pickable/graspable using the vacuum-based gripper.

Process 700 may then proceed to act 730, where the vacuum-based gripper may be activated to grasp a second container using at least one vacuum assembly of the vacuum-based gripper when the first container is located at the second position. For instance, the vacuum-based gripper may grasp a particular face (e.g., a side face) of the second container that is represented in image data captured by the at least one sensor when the first container is in the second position. In some instances, the second container may be the same container as the first container (i.e., the container that was pulled). In other instances, the second container may be a different container than the first container. For example, the second container may be a top-most container in a column of container including the first container.

FIG. 7 is a flowchart of a process 800 for detecting objects in an environment of the mobile robot, in accordance with some embodiments. As described herein, a mobile robot may include one or more sensors configured to capture information about the environment of the robot. The sensor(s) may include one or more perception modules that include a color camera (e.g., a red-green-blue (RGB) monocular camera) and a depth sensor (e.g., a time-of-flight (TOF) depth sensor) to determine one or more characteristics of objects (e.g., parcels, slips sheets, containers, etc.) in the environment. For instance, an RGB image captured by a color camera and depth information captured by a depth sensor may be combined to generate an RGBD image. The RGBD image may be conceptualized as a high-fidelity colorized 3D point cloud, which includes both color appearance as well as depth data and 3D geometric structure of objects in the environment. In some embodiments, the RGB image and the depth information are combined by registering the RGB image and the depth information to create the RGBD image.

Information about objects in the environment of the mobile robot may be determined based on the RGBD image. In some embodiments, the RGBD image is provided as input to a trained statistical model (e.g., a machine learning model) that has been trained to identify one or more characteristics of objects of interest. For instance, the statistical model may be trained to recognize surfaces (e.g., faces) of objects arranged in a stack. Any suitable type of trained statistical model may be used to process an RGBD image and output one or more characteristics of object(s) in the environment. In some embodiments, the trained statistical model is implemented as a neural network (e.g., a deep neural network) that includes a plurality of nodes arranged in layers and weights connecting the nodes between the layers. In some embodiments, the neural network is a convolutional neural network, a recurrent neural network, or a combination of types of neural networks.

Process 800 may begin in act 810, where objects of interest are detected in one or more images (e.g., RGBD images). The one or more images may include representations of one or more objects in an environment of the mobile robot, such as one or more containers, parcels, and/or slip sheets. The images may be analyzed using one or more trained object detection models to detect one or more two-dimensional (2D) object faces in the images.

Following object detection, process 800 may proceed to act 820, where poses for the detected objects are estimated. For a detected 2D object face, one or more corners of the detected 2D object face may be identified. A three-dimensional (3D) pose of the detected object may be determined based on the one or more corners and distance-based measurement data (e.g., TOF depth data of the RGBD image(s), such as a depth cloud). For example, a bounding box formed by the identified corners may be used to crop a depth cloud within the projected 2D region. A plane-fitting algorithm may be applied to the cropped depth cloud to determine a 3D pose of the detected object. The pose of the detected object may represent a rotation and/or position of the detected object. In some embodiments, one or more filters (e.g., an edge filter and/or a decimation filter) may be applied to the sensor data to reduce adversarial noise in the sensor data and enhance a stability of the pose.

Process 800 may then proceed to act 830, where object classification is determined to determine a type of the detected object(s) (e.g., parcels, slip sheets, containers, etc.). For instance, a cropped 2D image and cropped depth cloud data associated with a detected object may be processed using a trained machine learning (ML) model (e.g., a trained classification model, such as a residual network) to classify the detected object as a parcel, slip sheet, or a container. In some embodiments, the classification of a detected object may be verified based on characteristics of the detected object and typical characteristics of the object type. For example, the dimensions and/or a 2D reprojected model of the object may be compared to typical dimensions and/or object models for the corresponding object type (e.g., parcel, slip sheet, container, etc.). If the dimensions and/or a 2D reprojected model of the detected object match, or are within a threshold of similarity, the object type classification may be validated.

Process 800 may then proceed to act 840, where the poses estimated for detected containers may be refined. For instance, the detected containers may be clustered into individual columns (e.g., vertical or stacked arrangements of one or more containers in the stack of objects, which may be coupled by gravity), and a trained optimization model may process the pose estimates for a clustered column of containers to generate refined pose estimates. The trained optimization model may refine the pose estimates based on one or more constraints, which may include, but are not limited to, preventing intersections between the containers and surrounding surfaces (e.g., walls) and refining pose estimates for containers arranged in the same column to be share similarities. For example, the pose estimates for containers arranged in the same column are likely to have similar rotational orientations and positions (e.g., in vertical and horizontal planes).

FIG. 8 is a flowchart of a process 900 for selecting an object to be manipulated, in accordance with some embodiments. Process 900 begins in act 910, where it may be determined whether the detected objects include one or more pickable parcels. As described herein, a parcel may be determined to be pickable if most/all of a front surface, a side surface, or a top surface of the parcel is graspable using a vacuum-based gripper of a mobile robot. In some embodiments, it may be determined that the parcel is pickable using the estimated pose discussed herein in connection with FIG. 7.

In response to determining that at least one detected parcel is pickable, process 900 may proceed to act 950, where the at least one detected parcel is set as pickable. Setting the at least one detected parcel as pickable may include storing data identifying the object to be picked (e.g., in this instance, the at least one detected parcel), a type of the object to be picked (e.g., a parcel), and an action to be performed to manipulate the object (e.g., pick (e.g., grasp)).

The process 900 may then proceed to act 960, where it may be determined whether multiple pickable parcels were detected. If it is determined in act 960 that multiple pickable parcels were not detected, process 900 may proceed to act 640, where a top-priority object (e.g., the single, pickable, parcel) to be manipulated may be selected.

If it is determined in act 960 that multiple pickable parcels were detected, process 900 may proceed to act 630, where the detected pickable parcels may be ordered. Multiple detected pickable or pullable objects may be ordered based on the objects' position in a stack of objects (e.g., top-down, façade by façade, etc., a product or customer associated with the objects, or any other suitable factor. Process 900 may then proceed to act 640, where a top-priority object to be manipulated may be selected based on the ordering.

The top-priority object may be manipulated using a robotic end effector of the mobile robot, as described herein. The portion of the robotic end effector that is used to manipulate the object may depend on the action to be performed. For example, if the top-priority object is to be picked, the vacuum-based gripper of the robotic end effector may be used to grasp the object. As a further example, if the top-priority object is to be pulled, the hook assembly of the robotic end effector may be used to pull the object, as described herein in connection with FIGS. 9A-9E.

The manner in which the vacuum-based gripper is controlled to manipulate the object may depend on the type of object to be grasped. For example, if the top-priority object to be grasped is a parcel or a slip sheet, then the vacuum-based gripper may be used to grasp the object at any graspable face of the object (e.g., any face that is represented in image data received by the mobile robot). As a further example, if the top-priority object to be grasped is a container, then the vacuum-based gripper may be used to grasp the object at a particular face (or a subset of faces) of the object, such as a side surface of the container, as discussed herein in connection with FIGS. 9A-9E.

If it is determined in act 910, that none of the detected parcels are pickable, process 900 may proceed to act 920, where it is determined whether at least one of the detected slip sheets is pickable. A slip sheet may be determined to be pickable if at least a top surface of the parcel is graspable using the vacuum-based gripper. In some embodiments, it may be determined that the slip sheet is pickable using the estimated pose discussed herein in connection with FIG. 7.

If it is determined that at least one detected slip sheet is pickable, process 900 may proceed to act 950, where the at least one detected slip sheet is set as pickable. For example, data may be stored identifying the at least one detected slip sheet, an object type of a slip sheet, and an action indicating the at least one slip sheet is to be grasped. Process 900 may then proceed to the act 960, as described herein.

If it is determined in act 920 that none of the detected slip sheets are pickable, process 900 may proceed to act 930, where it may be determined whether at least one of the detected containers is pickable. As described herein, a container may be determined to be pickable if most/all of at least one particular pickable face (or subset of faces) of the container is represented in the image data. If it is determined in act 930 that at least one detected container is pickable, process 900 may proceed to act 950, where the at least one detected container is set as pickable. For example, data may be stored identifying the at least one detected container, indicating the at least one detected container is a container, and indicating that the at least one container is pickable. Process 900 may then proceed to the act 960, as described herein.

If it is determined in act 930 that none of the detected containers is pickable, process 900 may proceed to act 940, where it may be determined whether at least one of the detected containers is pullable. In some embodiments, a container may be determined to be pullable if the container is not on top of a parcel or slip sheet. Additionally, a container may be determined to be pullable if the container is a bottom-most container of a column of containers. In some embodiments, a container included in a column of containers may be determined to not be pullable if the total number of containers in the column of containers exceeds a threshold number of containers.

If it is determined in act 940 that at least one detected container is pullable, process 900 may proceed to act 955, where the at least one detected container is set as pullable. For example, data may be stored identifying the at least one detected container as a container and indicating the at least one detected container is pullable. Process 900 may then proceed to act 960, as described herein.

In some embodiments, process 900 may be performed based on detecting multiple objects in the environment of the mobile robot. For example, in instances where a single object is detected in the environment of the mobile robot, a pickability of the object may be determined without performing the entirety of process 900.

FIGS. 9A-E depict steps in a process for pulling a container using a hook assembly of the robotic end effector, in accordance with some embodiments. As shown, a robotic end effector 1010 may be controlled to pull a tote 1020 using a hook assembly 1320 from a first location to a second location. For instance, end effector 1010 may be controlled to pull the tote 1020 to the second location when it is determined that the tote 1020 is not pickable based on a particular face (e.g., a side surface) of the tote 1020 being at least partially hidden from view in image data received by the mobile robot. In the example illustrated in FIGS. 9A-E, the tote 1020 may be a bottom-most tote in a column of totes. In other examples, the tote 1020 may not be included in a column of totes. As shown in FIG. 9A, the robotic end effector 1010 may be controlled to move the hook assembly 1030 toward the tote 1020. In some embodiments, the robotic end effector 1010 may be controlled to move the hook assembly 1030 according to an estimated pose of the tote 1020, as described herein in connection with FIG. 7. In particular, the robotic end effector 1010 may be controlled to move the hook assembly 1030 toward a handle 1040 of the tote 1020, which may be disposed on a front face of the tote 1020. In some instances, such as is illustrated in FIGS. 9A-E, the handle 1040 may extend out from the front face of the tote 1020. In other instances, the handle 1040 may be recessed within the front face of the tote 1020.

As shown in FIG. 9B, the robotic end effector 1010 may be controlled to move toward the tote 1020 until contact 1050 is made between the hook assembly 1030 and the front face of tote 1020. In some embodiments, the contact 1050 may be between the hook assembly 1030 and a portion of the handle 1040, such as an inside or a recessed portion of the handle 1040. In some embodiments, the contact 1050 may be determined based on sensor data received from a force sensor of the robotic end effector 1010 or the hook assembly 1030 indicating the contact 1050. Additionally, or alternatively, the contact 1050 may be determined based on image data received from at least one camera of the mobile robot which may include a representation of the contact 1050.

As shown in FIG. 9C, the robotic end effector 1010 may be controlled to engage the hook assembly 1030 with the handle 1040 of the tote 1020. In particular, after determining the contact 1050, the robotic end effector 1010 may be controlled to move up to engage the hook assembly 1030 with a lower portion of the handle 1040, which may extend outwards from the front face of the tote 1020 or a recessed portion of the handle 1040. The hook assembly 1030 may be determined to be engaged with the handle 1040 when a contact 1060 is made between the hook assembly 1030 and the handle 1040. As described herein in connection with FIG. 9B, the contact 1060 may be determined based on sensor data received from a force sensor, image data received from the at least one camera, or using any other suitable sensor data.

As shown in FIG. 9D, the hook assembly 1030 engaged with the handle 1040 of the tote 1020 may be used to pull the tote 1020 to a new position. In some embodiments, pulling the tote 1020 may include controlling an arm 1080 of the mobile robot, to which the robotic end effector 1010 is coupled, to pull the tote 1020. For example, as shown in FIG. 9D, the arm 1080 may be moved toward the mobile robot to pull the tote 1020. Additionally, or alternatively, the tote 1020 may be pulled by controlling a mobile base 1070 of the mobile robot to move (e.g., drive) in a direction that the tote 1020 is to be pulled. For example, the mobile base 1070 may be controlled to drive the mobile robot away from the tote 1020 to pull the tote 1020 in the same direction as the mobile robot is being driven. In some embodiments, a combination of moving the mobile base 1070 and the arm 1080 may be used to move the tote 1020 to a target position. In some embodiments, the target position to which the tote 1020 is pulled may be a particular distance away from the initial position of the tote 1020 (e.g., in the stack of objects), such as a distance equal to the length of the tote or a known (e.g., average) length of a standard size tote.

As shown in FIG. 9E, after pulling the tote 1020 to a target position, the robotic end effector 1010 may be controlled to disengage the hook assembly 1030 from the handle 1040 of the tote 1020. For example, the robotic end effector 1010 may be controlled to move down (e.g., toward the ground) to disengage the hook assembly 1030 from the handle 1040 of the tote 1020. The robotic end effector 1010 may then be moved away from the tote 1020, such as by controlling the arm 1080 to move towards the mobile robot and/or controlling the mobile base 1070 to move away from the tote 1020.

In some embodiments, after pulling the tote 1020 to the target position, the mobile robot may be configured to determine whether the tote 1020 is graspable in the target position (e.g., whether a particular face (e.g., a side surface) of the tote 1020 is represented in additional image data), as discussed herein. When it is determined that the tote 1020 is not graspable in the position, one or more of the above steps shown in FIGS. 9A-E may be repeated to pull the tote 1020 to a new target position.

When it is determined that the tote 1020 is graspable in the target position, the vacuum-based gripper of the robotic end effector 1010 may be activated to grasp the tote 1020, as described herein. In some instances, a container grasped using the vacuum-based gripper may be different from the container pulled using the hook assembly (e.g., the hook assembly 1030) to a target position. For example, in instances where the tote 1020 being pulled is included in a column of totes, as illustrated in FIGS. 9A-E, pulling the tote 1020 to the position may also move the other totes included in the column of totes to the target position. As such, in some instances, after pulling the tote 1020 to the target position, the mobile robot may be configured to determine whether another tote in the column of totes is graspable in the position, such as a top-most tote in the column of totes. When it is determined that the other tote is graspable in the position, the vacuum-based gripper of the robotic end effector 1010 may be activated to grasp the other tote.

In some such embodiments, the mobile robot may be configured to pull the tote 1020 to the target position based, at least in part, on determining the other tote (e.g., a top-most tote in a column of totes) is not graspable in its initial position. In some embodiments, after pulling the tote 1020 to the position, the vacuum-based gripper may be controlled to sequentially grasp each tote in the column of totes starting with the top-most tote in the column.

FIG. 10 depicts grasping of a container using a vacuum-based gripper of a mobile robot, in accordance with some embodiments. The mobile robot may be configured to determine a grasp strategy for grasping an object, such as a container, parcel, or slip sheet. The grasp strategy planning may, for example, select from among multiple grasp candidates, each of which describes a manner in which to grasp the target object. Grasp strategy planning may include, but is not limited to, the placement of a gripper of the robotic device on (or near) a surface of the selected object and one or more movements of the robotic device (a grasp trajectory) necessary to achieve such gripper placement on or near the selected object.

In some embodiments, the grasp strategy may be dependent on the type of object to be grasped. For example, as described herein, a container (e.g., tote 1110) may have a limited set of faces on which a successful grasp using a vacuum-based gripper can be achieved. For instance, a tote 1110 may only be successfully grasped by vacuum-based gripper 1130 on a side surface 1120 of the tote 1110. When positioned in contact with or near side surface 1120, the vacuum-based gripper 1130 may be activated to provide vacuum to the one or more vacuum assemblies 1140 for grasping the side surface 1120 of the tote 1110. In some embodiments, a side surface of a particular types of containers (e.g., totes) may be angled. For example, as shown in FIG. 10, the side surface 1120 of the tote 1110 may be set at an angle 1150 relative to a surface on which the tote 1110 is located. In some such embodiments, controlling the vacuum-based gripper 1130, according to a grasp strategy, to grasp the tote 1110 may include angling the vacuum-based gripper 1130 to align with the angle 1150 of the tote 1110. Angling the vacuum-based gripper 1130 to align with the angle 1150 of the tote 1110 may increase the number of vacuum assemblies 1140 that contact the tote 1110 (or the surface area of contact) and, therefore, grasp the side surface 1120 of the tote 1110 when the vacuum-based gripper 1130 is activated.

Some containers have non-vertical sides and/or other features that may impact grasping performance of the container with a vacuum-based gripper (e.g., due to collisions of the vacuum-based gripper and the container) if not taken into consideration when performing grasp planning. For example, the top surface of some types of containers may include a portion (e.g., a lip portion) that extends laterally over a side surface of the container. In some embodiments, a mobile robot may be configured to take into consideration the presence of such container features when performing grasp planning. For example, the grasp planning process may be constrained such that when a first container is grasped, a portion of the vacuum-based gripper (e.g., one or more vacuum assemblies) does not engage with a second container located adjacent to the first container, an example of which is shown in FIGS. 11A-11B.

FIG. 11A depicts an unsuccessful grasp attempt of a container using a vacuum-based gripper of a mobile robot, in accordance with some embodiments. As shown in FIG. 11A, when the tote 1210 is included in a column of totes 1270, attempting to grasp a side surface of the tote 1210 may result in contact 1250 of the vacuum-based gripper with a lip portion of a tote positioned below tote 1210 in the column of totes 1270.

FIG. 11B depicts a successful grasp attempt of a container using a vacuum-based gripper of a mobile robot, in accordance with some embodiments. As shown in FIG. 11B, the vacuum-based gripper position has been shifted vertically upward relative to the vacuum-based gripper position shown in FIG. 11A, such that no portion of the vacuum-based gripper engages with the lip portion of the tote located below tote 1210, which may avoid a collision of the vacuum-based gripper with the lower tote when the grasp of tote 1210 is attempted As described herein, a hook assembly of a vacuum-based gripper, which may be used to pull containers from a first position to second position, may extend beyond the footprint of the vacuum-based gripper surface. As such, the inclusion of a hook assembly on the vacuum-based gripper may impact grasp planning when determining how to grasp a container that has been moved into a position in which a successful grasp may be attempted.

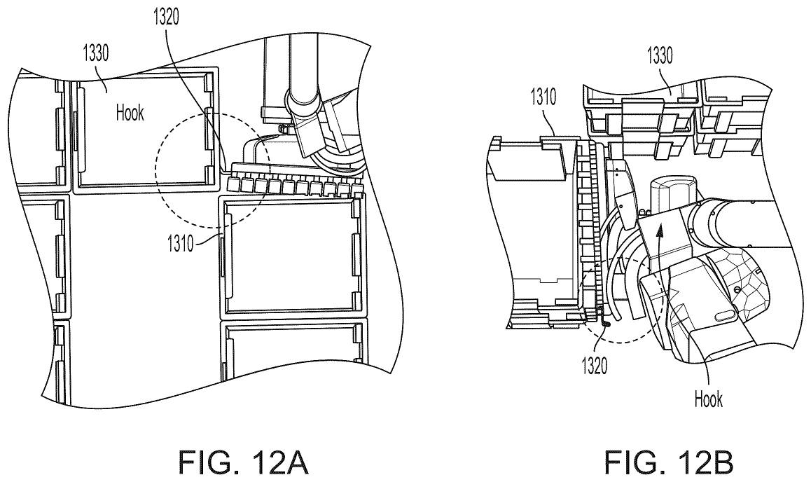

FIGS. 12A-B depict positions of a hook assembly of a vacuum-based gripper for a mobile robot when attempting to grasping a container using the vacuum-based gripper, in accordance with some embodiments. In particular, FIG. 12A depicts an orientation of a vacuum-based gripper in which hook assembly 1320 collides with an adjacent tote 1330 when attempting to grasp a tote 1310. FIG. 12B depicts a different orientation of the vacuum-based gripper in which the hook assembly 1320 is oriented away from adjacent tote 1330 when attempting to grasp the tote 1310, which prevents a collision between the hook assembly 1320 and the adjacent tote 1330.

FIG. 13 is a flowchart of a process 1400 for optimizing a virtual trajectory for moving a grasped container, in accordance with some embodiments. Process 1400 begins in act 1410, where a virtual trajectory is generated for placing a grasped container at a target location. The virtual trajectory may correspond to an estimated trajectory through which an arm of the mobile robot is to be moved to place the grasped container at the target location.

In some embodiments, the virtual trajectory may be generated based on a goal pose representing a pose in which the grasped container is to be placed in at the target location. The goal pose of the grasped container may be selected from a set of possible goal poses in which the grasped container may be placed. The set of possible goal poses may be filtered using one or more constraints. For example, the set of possible goal poses may be filtered based on an orientation constraint representing that the container is to be in an upright position in the goal pose. Additionally, the set of possible goal poses may be filtered based on an optimization constraint representing goal poses for which generation of an optimized trajectory exceeds a time and/or compute threshold. In some embodiments, if no goal poses remaining after filtering based on the constraints, the optimization constraint may be bypassed to allow for selection of a goal pose that would have been filtered out based on the optimization constraint.

Process 1400 may then proceed to act 1420, where one or more intermediate poses of the virtual trajectory may be generated. An intermediate pose may represent a position of the portion of the mobile robot and/or the grasped container at a point in time during the estimated trajectory. An intermediate pose may be generated based on an orientation constraint representing that a grasped container is to remain upright throughout the trajectory. If the orientation of the container at a generated intermediate pose is determined to not be upright (e.g., rather, upside down, angled, etc.), the intermediate pose may be adjusted or a new intermediate pose may be generated.

Process 1400 may then proceed to act 1430, where the one or more intermediate poses may be adjusted. An intermediate pose may be adjusted based on a collision constraint, which may represent, for example, that a grasped container is not to collide with a surface and/or object during the trajectory. If the position of a container at a given intermediate pose is determined to collide with a surface and/or object (e.g., share a position with the surface and/or object), the intermediate pose may be adjusted to prevent the collision.

Process 1400 may then proceed to act 1440, where the virtual trajectory may be optimized based on the adjusted intermediate poses. For instance, the adjusted intermediate poses may be used by a trained trajectory optimization model to generate a final trajectory for moving the grasped container to a target location. The final trajectory may include the adjusted intermediate poses and one or more additional intermediate poses.

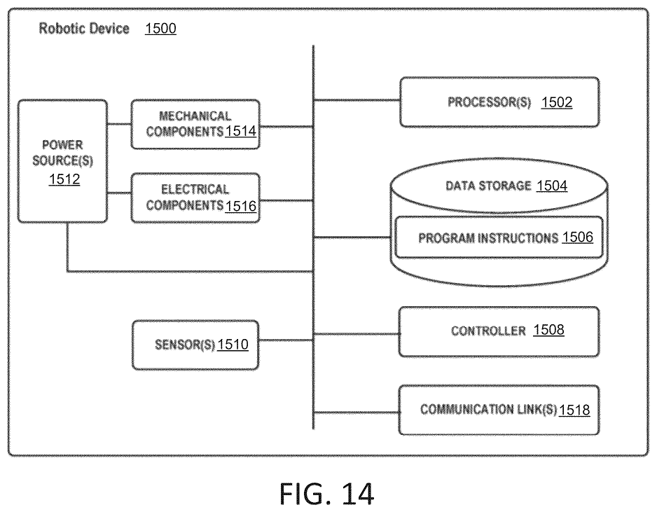

FIG. 14 illustrates an example configuration of a robotic device (or “robot”) 1500, according to an illustrative embodiment of the invention. The robotic device 1500 represents an example robotic device configured to perform the operations described herein. Additionally, the robotic device 1500 may be configured to operate autonomously, semi-autonomously, and/or using directions provided by user(s), and may exist in various forms, such as a humanoid robot, biped, quadruped, or other mobile robot, among other examples. Furthermore, the robotic device 1500 may also be referred to as a robotic system, mobile robot, or robot, among other designations.

As shown in FIG. 14, the robotic device 1500 includes processor(s) 1502, data storage 1504, program instructions 1506, controller 1508, sensor(s) 1510, power source(s) 1512, mechanical components 1514, and electrical components 1516. The robotic device 1500 is shown for illustration purposes and may include more or fewer components without departing from the scope of the disclosure herein. The various components of robotic device 1500 may be connected in any manner, including via electronic communication means, e.g., wired or wireless connections. Further, in some examples, components of the robotic device 1500 may be positioned on multiple distinct physical entities rather on a single physical entity. Other example illustrations of robotic device 1500 may exist as well.

Processor(s) 1502 may operate as one or more general-purpose processor or special purpose processors (e.g., digital signal processors, application specific integrated circuits, etc.). The processor(s) 1502 can be configured to execute computer-readable program instructions 1506 that are stored in the data storage 1504 and are executable to provide the operations of the robotic device 1500 described herein. For instance, the program instructions 1506 may be executable to provide operations of controller 1508, where the controller 1508 may be configured to cause activation and/or deactivation of the mechanical components 1514 and the electrical components 1516. The processor(s) 1502 may operate and enable the robotic device 1500 to perform various functions, including the functions described herein.

The data storage 1504 may exist as various types of storage media, such as a memory. For example, the data storage 1504 may include or take the form of one or more computer-readable storage media that can be read or accessed by processor(s) 1502. The one or more computer-readable storage media can include volatile and/or non-volatile storage components, such as optical, magnetic, organic or other memory or disc storage, which can be integrated in whole or in part with processor(s) 1502. In some implementations, the data storage 1504 can be implemented using a single physical device (e.g., one optical, magnetic, organic or other memory or disc storage unit), while in other implementations, the data storage 1504 can be implemented using two or more physical devices, which may communicate electronically (e.g., via wired or wireless communication). Further, in addition to the computer-readable program instructions 1506, the data storage 1504 may include additional data such as diagnostic data, among other possibilities.

The robotic device 1500 may include at least one controller 108, which may interface with the robotic device 1500. The controller 1508 may serve as a link between portions of the robotic device 1500, such as a link between mechanical components 1514 and/or electrical components 1516. In some instances, the controller 108 may serve as an interface between the robotic device 1500 and another computing device. Furthermore, the controller 1508 may serve as an interface between the robotic device 1500 and a user(s). The controller 1508 may include various components for communicating with the robotic device 1500, including one or more joysticks or buttons, among other features. The controller 1508 may perform other operations for the robotic device 1500 as well. Other examples of controllers may exist as well.

Additionally, the robotic device 1500 includes one or more sensor(s) 1510 such as force sensors, proximity sensors, motion sensors, load sensors, position sensors, touch sensors, depth sensors, ultrasonic range sensors, and/or infrared sensors, among other possibilities. The sensor(s) 1510 may provide sensor data to the processor(s) 1502 to allow for appropriate interaction of the robotic device 1500 with the environment as well as monitoring of operation of the systems of the robotic device 1500. The sensor data may be used in evaluation of various factors for activation and deactivation of mechanical components 1514 and electrical components 1516 by controller 1508 and/or a computing system of the robotic device 1500.

The sensor(s) 1510 may provide information indicative of the environment of the robotic device for the controller 1508 and/or computing system to use to determine operations for the robotic device 1500. For example, the sensor(s) 1510 may capture data corresponding to the terrain of the environment or location of nearby objects, which may assist with environment recognition and navigation, etc. In an example configuration, the robotic device 1500 may include a sensor system that may include a camera, RADAR, LIDAR, time-of-flight camera, global positioning system (GPS) transceiver, and/or other sensors for capturing information of the environment of the robotic device 1500. The sensor(s) 1510 may monitor the environment in real-time and detect obstacles, elements of the terrain, weather conditions, temperature, and/or other parameters of the environment for the robotic device 1500.

Further, the robotic device 1500 may include other sensor(s) 1510 configured to receive information indicative of the state of the robotic device 1500, including sensor(s) 1510 that may monitor the state of the various components of the robotic device 1500.

The sensor(s) 1510 may measure activity of systems of the robotic device 1500 and receive information based on the operation of the various features of the robotic device 1500, such the operation of extendable legs, arms, or other mechanical and/or electrical features of the robotic device 1500. The sensor data provided by the sensors may enable the computing system of the robotic device 1500 to determine errors in operation as well as monitor overall functioning of components of the robotic device 1500.

For example, the computing system may use sensor data to determine the stability of the robotic device 1500 during operations as well as measurements related to power levels, communication activities, components that require repair, among other information. As an example configuration, the robotic device 1500 may include gyroscope(s), accelerometer(s), and/or other possible sensors to provide sensor data relating to the state of operation of the robotic device. Further, sensor(s) 1510 may also monitor the current state of a function, such as a gait, that the robotic device 1500 may currently be operating. Additionally, the sensor(s) 1510 may measure a distance between a given robotic leg of a robotic device and a center of mass of the robotic device. Other example uses for the sensor(s) 1510 may exist as well.

Additionally, the robotic device 1500 may also include one or more power source(s) 1512 configured to supply power to various components of the robotic device 1500. Among possible power systems, the robotic device 1500 may include a hydraulic system, electrical system, batteries, and/or other types of power systems. As an example illustration, the robotic device 1500 may include one or more batteries configured to provide power to components via a wired and/or wireless connection. Within examples, components of the mechanical components 1514 and electrical components 1516 may each connect to a different power source or may be powered by the same power source. Components of the robotic device 1500 may connect to multiple power sources as well.

Within example configurations, any type of power source may be used to power the robotic device 1500, such as a gasoline and/or electric engine. Further, the power source(s) 1512 may charge using various types of charging, such as wired connections to an outside power source, wireless charging, combustion, or other examples. Other configurations may also be possible. Additionally, the robotic device 1500 may include a hydraulic system configured to provide power to the mechanical components 1514 using fluid power. Components of the robotic device 1500 may operate based on hydraulic fluid being transmitted throughout the hydraulic system to various hydraulic motors and hydraulic cylinders, for example. The hydraulic system of the robotic device 1500 may transfer a large amount of power through small tubes, flexible hoses, or other links between components of the robotic device 1500. Other power sources may be included within the robotic device 1500.

Mechanical components 1514 can represent hardware of the robotic device 1500 that may enable the robotic device 1500 to operate and perform physical functions. As a few examples, the robotic device 1500 may include actuator(s), extendable leg(s) (“legs”), arm(s), wheel(s), one or multiple structured bodies for housing the computing system or other components, and/or other mechanical components. The mechanical components 1514 may depend on the design of the robotic device 1500 and may also be based on the functions and/or tasks the robotic device 1500 may be configured to perform. As such, depending on the operation and functions of the robotic device 1500, different mechanical components 1514 may be available for the robotic device 1500 to utilize. In some examples, the robotic device 1500 may be configured to add and/or remove mechanical components 1514, which may involve assistance from a user and/or other robotic device. For example, the robotic device 1500 may be initially configured with four legs, but may be altered by a user or the robotic device 1500 to remove two of the four legs to operate as a biped. Other examples of mechanical components 1514 may be included.

The electrical components 1516 may include various components capable of processing, transferring, providing electrical charge or electric signals, for example. Among possible examples, the electrical components 1516 may include electrical wires, circuitry, and/or wireless communication transmitters and receivers to enable operations of the robotic device 1500. The electrical components 1516 may interwork with the mechanical components 1514 to enable the robotic device 1500 to perform various operations. The electrical components 1516 may be configured to provide power from the power source(s) 1512 to the various mechanical components 1514, for example. Further, the robotic device 1500 may include electric motors. Other examples of electrical components 1516 may exist as well.

In some implementations, the robotic device 1500 may also include communication link(s) 1518 configured to send and/or receive information. The communication link(s) 1518 may transmit data indicating the state of the various components of the robotic device 1500. For example, information read in by sensor(s) 1510 may be transmitted via the communication link(s) 1518 to a separate device. Other diagnostic information indicating the integrity or health of the power source(s) 1512, mechanical components 1514, electrical components 1516, processor(s) 1502, data storage 1504, and/or controller 1508 may be transmitted via the communication link(s) 1518 to an external communication device.

In some implementations, the robotic device 1500 may receive information at the communication link(s) 1518 that is processed by the processor(s) 1502. The received information may indicate data that is accessible by the processor(s) 1502 during execution of the program instructions 1506, for example. Further, the received information may change aspects of the controller 1508 that may affect the behavior of the mechanical components 1514 or the electrical components 1516. In some cases, the received information indicates a query requesting a particular piece of information (e.g., the operational state of one or more of the components of the robotic device 1500), and the processor(s) 1502 may subsequently transmit that particular piece of information back out the communication link(s) 1518.

In some cases, the communication link(s) 1518 include a wired connection. The robotic device 1500 may include one or more ports to interface the communication link(s) 1518 to an external device. The communication link(s) 1518 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

1. A robotic end effector for a mobile robot, the robotic end effector comprising:
a vacuum-based gripper including a set of vacuum assemblies; and
a hook assembly configured to engage with a portion of a container, the hook assembly including a first portion mechanically coupled to the vacuum-based gripper and a second portion extending at a first angle relative to the first portion, the first portion extending at a second angle relative to a suction direction of the set of vacuum assemblies.

2. The robotic end effector of claim 1, further comprising:
an adapter plate mechanically coupled to the first portion of the hook assembly and at least one vacuum assembly in the set of vacuum assemblies.

3. The robotic end effector of claim 2, wherein the adapter plate includes at least one opening through which at least a portion of the at least one vacuum assembly extends.

4. The robotic end effector of claim 1, wherein the first portion of the hook assembly is mechanically coupled to at least one vacuum assembly in the set of vacuum assemblies, and the robotic end effector further comprises:
at least one washer positioned between the first portion of the hook assembly and the at least one vacuum assembly.

5. The robotic end effector of claim 1, further comprising:
at least one magnet and/or spring mechanically coupled to the first portion of the hook assembly and the vacuum-based gripper,
wherein the at least one magnet and/or spring is configured to decouple from the hook assembly and/or the vacuum-based gripper when a force applied to at least a portion of the hook assembly exceeds a threshold amount of force.

6-9. (canceled)

10. A method comprising:
identifying, using first image data including a representation of one or more parcels and one or more containers, a first container located at a first position in an environment of a mobile robot;
controlling the mobile robot to pull the first container from the first position to a second position in the environment using a hook assembly coupled to a vacuum-based gripper of the mobile robot; and
activating the vacuum-based gripper to grasp a second container using at least one vacuum assembly of the vacuum-based gripper when the first container is located at the second position.

11. The method of claim 10, wherein the first container and the second container are a same container.

12. (canceled)

13. The method of claim 10, wherein identifying, using the first image data, the first container located at the first position comprises:
identifying a third container represented in the first image data; and
identifying the first container, based, at least in part, on identifying the third container.

14-15. (canceled)

16. The method of claim 10, further comprising:
identifying, using the first image data, at least one corner of the first container; and
determining, based, at least in part, on the at least one corner and distance-based measurement data for the first container, a pose of the first container,
wherein controlling the mobile robot to use the hook assembly to pull the first container from the first position to the second position in the environment is based, as least in part, on the pose of the first container.

17. The method of claim 10, wherein identifying, using the first image data, the first container located at the first position in the environment of the mobile robot comprises:
determining, using a machine learning (ML) model, that a first object represented in the first image data corresponds to a container; and
identifying the first container, based, at least in part, on determining the first object corresponds to a container.

18. The method of claim 17, further comprising:
verifying that the first object corresponds to a container based on the first object having a first characteristic of a container; and
identifying the first container, based, at least in part, on verifying that the first object corresponds to a container.

19. The method of claim 18, wherein verifying that the first object corresponds to a container based on the first object having the first characteristic of a container comprises:
determining dimensions of the first object match predetermined dimensions of a container.

20. The method of claim 13, further comprising:
determining a first pose of the first container;
determining a second pose of the third container; and
adjusting the first pose and the second pose to include a same orientation and position in at least two planes based on the first container and the third container being aligned in a column,
wherein controlling the mobile robot to use the hook assembly to pull the first container from the first position to the second position is based on the first pose.

21. The method of claim 10, wherein controlling the mobile robot to use the hook assembly to pull the first container from the first position to the second position comprises:
determining whether a first portion of a first face of the second container is represented in the first image data when the first container is in the first position; and
controlling the mobile robot to use the hook assembly to pull the first container from the first position to the second position when it is determined that the first portion of first face of the second container is not represented in the first image data.

22. (canceled)

23. The method of claim 21, wherein controlling the mobile robot to use the hook assembly to pull the first container from the first position to the second position comprises:
determining whether at least one object represented in the first image data is graspable using the at least one vacuum assembly of the vacuum-based gripper; and
controlling the mobile robot to use the hook assembly to pull the first container from the first position to the second position when it is determined that the first portion of the first face of the second container is not represented in the first image data and the at least one object is not graspable using the at least one vacuum assembly of the vacuum-based gripper.

24. The method of claim 23, wherein the at least one object includes a first parcel and a first slip sheet, and wherein controlling the mobile robot to use the hook assembly to pull the first container from the first position to the second position comprises:
determining whether the first parcel is graspable using the at least one vacuum assembly of the vacuum-based gripper, wherein the first parcel is in a third position;
determining whether the first slip sheet is graspable using the at least one vacuum assembly of the vacuum-based gripper when it is determined that the first parcel is not graspable using the at least one vacuum assembly of the vacuum-based gripper when the first parcel is in the third position, wherein the first slip sheet is in a fourth position;
determining whether the first face of the second container is graspable using the at least one vacuum assembly of the vacuum-based gripper when it is determined that the first slip sheet is not graspable using the at least one vacuum assembly of the vacuum-based gripper when the first slip sheet is in the fourth position; and
controlling the mobile robot to use the hook assembly to pull the first container from the first position to the second position when it is determined that the first face of the second container is at least partially hidden from view in the first image data, the first parcel is not graspable using the at least one vacuum assembly of the vacuum-based gripper when the first parcel is in the third position, and the first slip sheet is not graspable using the at least one vacuum assembly of the vacuum-based gripper when the first slip sheet is in the fourth position.

25. The method of claim 10, wherein controlling the mobile robot to use the hook assembly to pull the first container from the first position to the second position comprises:
controlling the mobile robot to engage the hook assembly with a handle of the first container; and
controlling the mobile robot to pull the first container from the first position to the second position via the hook assembly when engaged with the handle of the first container.

26-31. (canceled)

32. The method of claim 10, wherein the first container is included in a column of containers and controlling the mobile robot to use the hook assembly to pull the first container from the first position to the second position comprises:
controlling the mobile robot to use the hook assembly to pull the column of containers from the first position to the second position by pulling the first container to the second position.

33-34. (canceled)

35. The method of claim 10, wherein controlling the mobile robot to use the hook assembly to pull the first container from the first position to the second position comprises:
controlling the mobile robot to use the hook assembly to pull the first container from the first position to a third position;
determining, using second image data, whether a first portion of first face of the first container is represented in the second image data; and
controlling the mobile robot to use the hook assembly to pull the first container from the third position to the second position when it is determined that the first portion of the first face of the first container is not represented in the second image data.

36. The method of claim 10, wherein activating the vacuum-based gripper to grasp the first container using the at least one vacuum assembly of the vacuum-based gripper when the first container is located at the second position comprises:
determining whether a first portion of a first face of the first container is represented in second image data representing the first container located at the second position; and
activating the vacuum-based gripper to grasp the first container using the at least one vacuum assembly of the vacuum-based gripper when it is determined that the first portion of the first face of the first container is represented in the second image data.

37. The method of claim 10, wherein activating the vacuum-based gripper to grasp the first container using the at least one vacuum assembly of the vacuum-based gripper when the first container is located at the second position comprises:
controlling the mobile robot to activate suction to the at least one vacuum assembly of the vacuum-based gripper; and
controlling the mobile robot to grasp a side face of the first container using the at least one vacuum assembly of the vacuum-based gripper, the side face being orthogonal to a front face and a top face of the first container.

38. The method of claim 10, wherein activating the vacuum-based gripper to grasp the first container using the at least one vacuum assembly of the vacuum-based gripper when the first container is located at the second position comprises:
controlling the mobile robot to orient the vacuum-based gripper in an orientation such that the hook assembly extends past a front face of the first container; and
controlling the mobile robot to grasp the first container using the at least one vacuum assembly of the vacuum-based gripper when the vacuum-based gripper is in the orientation.

39-40. (canceled)

41. The method of claim 10, wherein the first container is in a first orientation when grasped using the at least one vacuum assembly of the vacuum-based gripper, and wherein the method further comprises:
controlling the mobile robot to place the first container at a target location, the first container being placed in the first orientation at the target location.

42. The method of claim 41, further comprising:
generating a trajectory for placing the first container in the target location, the trajectory including at least one first intermediate pose of the mobile robot;
determining whether the first container is in the first orientation in the at least one first intermediate pose;
determining whether a collision between the first container and at least one first surface is represented in the at least one first intermediate pose; and
generating at least one second intermediate pose when it is determined that the first container is not in the first orientation in the at least one first intermediate pose or there is a determined collision between the first container and the at least one first surface represented in the at least one first intermediate pose.

43. A mobile robot comprising:
at least one first sensor configured to sense first image data;
a robotic arm;
a vacuum-based gripper coupled to the robotic arm, the vacuum-based gripper comprising at least one vacuum assembly and a hook assembly; and
a controller configured to:
receive the first image data from the at least one first sensor, the first image data including a representation of one or more parcels and one or more containers in an environment of the mobile robot;
identify, using the first image data, a first container located at a first position in the environment of the mobile robot;
control the mobile robot to pull the first container from the first position to a second position in the environment using the hook assembly; and
activate the vacuum-based gripper to grasp a second container using the at least one vacuum assembly when the first container is located at the second position.

44-75. (canceled)
